(19) United States
(12) Patent Application Publication
(10) Pub. No.: US 2019/0095227 A1
(43) Pub. Date: Mar. 28, 2019

(54) VEHICLE CONTROL DEVICE

(71) Applicant: LG Electronics Inc., Seoul (KR)

(72) Inventors: Inyoung HWANG, Seoul (KR); Sanga KIM, Seoul (KR); Kyoungha LEE, Seoul (KR); Taeyoung JEON, Seoul (KR); Kangmin KIM, Seoul (KR)

(21) Appl. No.: 15/855,733

(22) Filed: Dec. 27, 2017

(30) Foreign Application Priority Data
Sep. 25, 2017 (KR) 10-2017-0123688

(51) Int. Cl. G06F 9/451; H04W 12/06; G06K 9/00; G06F 3/0481; G06F 3/0487

(52) U.S. Cl. CPC G06F 9/451; H04W 12/06; G06K 9/00013; G05D 1/0231; G06F 3/0487; G06K 9/00087; G06F 3/04817

(57) ABSTRACT

A vehicle control device includes: a display; a steering wheel; and a vehicle button arranged to be overlapped with a fingerprint scanner at one point of the steering wheel. The vehicle control device further includes: a communication unit configured to communicate with a mobile terminal, the display and the vehicle button; and a processor configured to determine a type of a screen to be displayed on the display, according to whether a fingerprint recognized by the fingerprint scanner matches fingerprint information received from the mobile terminal, if the fingerprint scanner recognizes a fingerprint of a finger which has applied a push input to the vehicle button, and the processor configured to control the display such that the determined screen is displayed.

### CROSS-REFERENCE TO RELATED APPLICATION

Pursuant to 35 U.S.C. § 119(a), this application claims the benefit of an earlier filing date of and the right of priority to Korean Application No. 10-2017-0123688, filed on Sep. 25, 2017, the contents of which are incorporated by reference herein in its entirety.

### BACKGROUND

### 1. Field of the Invention

This specification relates to a vehicle control device capable of controlling one or more displays mounted to a vehicle, and a mobile terminal which communicates with the vehicle control device.

### 2. Background of the Invention

A vehicle is a traffic means capable of carrying persons or baggage by using a kinetic energy, and representative examples thereof may be a car and a motorcycle.

For safety and convenience of a user of such a vehicle, various types of sensors and devices are provided at the vehicle, and the vehicle becomes multifunctional.

The vehicle may have a convenience function for enhancing a driver convenience, and a safety function for safety of a driver and/or a pedestrian.

Firstly, the convenience function provides an infortainment (information+entertainment) function to the vehicle, and supports a partial autonomous driving function. Alternatively, the convenience function is related to a driver convenience, e.g., help to obtain a driver's viewing such as a nighttime viewing or a blind spot. For instance, the convenience function includes an active cruise control (ACC), a smart parking assist system (SPAS), a night vision (NV), a head up display (HUD), an around view monitor (AVM), an adaptive headlight system (AHS), etc.

The safety function is related to a technique to obtain a driver's safety and/or a pedestrian's safety, and includes a lane departure warning system (LDWS), a lane keeping assist system (LKAS), an autonomous emergency braking (AEB), etc.

The vehicle is provided with one or more displays for at least one passenger who is in the vehicle, and various driving information is provided through the displays as the vehicle becomes multifunctional. As the display is changed into a device which communes with a user from a device which merely transmits information, a user interface for controlling the display inside the vehicle is required.

As smart phones become popular recently, a passenger who uses the vehicle generally owns his or her mobile terminal. The mobile terminal may serve as an input means for controlling the vehicle, or an information provider for providing various types of information to the vehicle.

It is also required to develop a user interface capable of enhancing a user convenience between the vehicle and the mobile terminal.

### SUMMARY

Therefore, an aspect of the detailed description is to provide a vehicle control device, a mobile terminal, and a system including the same, the vehicle control device capable of providing a novel type of user interface for connection between a vehicle and the mobile terminal.

Another aspect of the detailed description is to provide a vehicle control device, a mobile terminal, and a system including the same, the vehicle control device capable of restricting a third party who drives a vehicle from accessing the mobile terminal which can be utilizable as an information provider with respect to the vehicle.

Another aspect of the detailed description is to provide a vehicle control device, a mobile terminal, and a system including the same, the vehicle control device capable of controlling the mobile terminal by using a home button provided at the vehicle.

Another aspect of the detailed description is to provide a vehicle control device, a mobile terminal, and a system including the same, the vehicle control device capable of restricting an access to the mobile terminal by executing a different function according to a driver, even if the same user input is applied to the home button.

To achieve these and other advantages and in accordance with the purpose of this specification, as embodied and broadly described herein, there is provided a vehicle control device, comprising: a display; a steering wheel; and a vehicle button arranged to be overlapped with a fingerprint scanner at one point of the steering wheel, wherein the vehicle control device further comprises: a communication unit configured to communicate with a mobile terminal, the display and the vehicle button; and a processor configured to determine a type of a screen to be displayed on the display, according to whether a fingerprint recognized by the fingerprint scanner matches fingerprint information received from the mobile terminal, if the fingerprint scanner recognizes the fingerprint of a finger which has applied a push input to the vehicle button, and the processor configured to control the display such that the determined screen is displayed.

In an embodiment, if the recognized fingerprint matches the received fingerprint information, a first access right is provided to a user. And if the recognized fingerprint does not match the received fingerprint information, a second access right having a lower level than the first access right is provided to the user.

In an embodiment, the number of functions executable in the vehicle by the user is variable according to an access right.

In an embodiment, if a user input is applied to the vehicle button in a state that the vehicle has the first access right, the processor executes a first function. And if the user input is applied to the vehicle button in a state that the vehicle has the second access right, the processor executes a second function different from the first function.

In an embodiment, if the recognized fingerprint matches the received fingerprint information, the processor controls the communication unit such that a first screen is displayed on the display. And if the recognized fingerprint does not match the received fingerprint information, the processor controls the communication unit such that a second screen rather than the first screen is displayed on the display.

To achieve these and other advantages and in accordance with the purpose of this specification, as embodied and broadly described herein, there is also provided a mobile terminal, comprising: a button configured to receive a push input; a fingerprint scanner arranged to be overlapped with the button, and configured to recognize a fingerprint of a finger contacting the button; a communication unit configured to communicate with at least one processor provided at a vehicle having a display; and a controller configured to determine a type of a screen to be displayed on the display, according to whether the fingerprint recognized by the fingerprint scanner matches fingerprint information received from the vehicle, if the fingerprint scanner recognizes the fingerprint of the finger which has applied a push input to the button, and the controller configured to control the communication unit such that the determined screen is displayed on the display.

In an embodiment, a first access right is provided to the vehicle if the recognized fingerprint matches the received fingerprint information, and a second access right having a lower level than the first access right is provided to the vehicle if the recognized fingerprint does not match the received fingerprint information.

In an embodiment, if a new push input is applied to the button in a state that one of the first and second access rights is provided to the vehicle, the controller updates the one into the other, according to whether the fingerprint recognized by the fingerprint scanner matches the fingerprint information received from the vehicle.

In an embodiment, the number of applications which are usable on the vehicle among applications installed at the mobile terminal is variable according to an access right.

In an embodiment, the controller executes a first function if a user input is applied to the vehicle button provided at the vehicle in a state that the vehicle has the first access right, and the controller executes a second function different from the first function if the user input is applied to the vehicle button in a state that the vehicle has the second access right.

In an embodiment, if the recognized fingerprint matches the received fingerprint information, the controller controls the communication unit such that the first screen is displayed on the display. And if the recognized fingerprint does not match the received fingerprint information, the controller controls the communication unit such that the second screen rather than the first screen is displayed on the display.

In an embodiment, the mobile terminal further comprises a memory configured to store a plurality of applications. And the first screen includes an icon of an application included in a first group among the applications, and the second screen includes an icon of an application included in a second group among the applications.

In an embodiment, the first screen includes a home button set to display a home screen page, and the second screen does not include the home button.

In an embodiment, if a preset condition is satisfied, the controller controls the communication unit such that the determined screen is displayed on the display. The preset condition is a case where a first push input is applied to the button and a second push input is applied to the vehicle button provided at the vehicle, within a predetermined time. And the fingerprint information is generated by the second push input.

In an embodiment, if the preset condition is satisfied, the controller controls the communication unit such that a preset type of connection is established between the vehicle and the mobile terminal.

In an embodiment, after the connection is established, the controller receives a user input applied to the vehicle button through the communication unit, and controls the communication unit such that a different screen is displayed on the display according to the user input.

In an embodiment, the controller controls the communication unit such that a different screen is displayed on the display according to whether the vehicle is in a manual driving state or an autonomous driving state, even if the same user input is applied to the vehicle button.

In an embodiment, if one of the first and second push inputs is applied, the controller controls the communication unit such that guidance information indicating the predetermined time is displayed on the display.

In an embodiment, if one of the first and second push inputs is applied, the predetermined time is counted. And if another of the first and second push inputs is not applied within the predetermined time, the determined screen is not displayed on the display.

In an embodiment, if a push input is applied to the button, the controller controls the communication unit such that a message requesting the fingerprint information is transmitted to the vehicle.

The present invention may be extended up to a vehicle provided with the aforementioned vehicle control device, and/or a vehicle control method.

The vehicle control device according to the present invention and a vehicle having the same may have the following advantages.

Firstly, a user may use the vehicle button mounted to the vehicle as an input means for controlling the mobile terminal, as well as a means for controlling the vehicle. This may enhance a user convenience.

An owner of the vehicle may request a driving of the vehicle to a deputy driver. In this case, there are needs that the owner does not wish to provide all information stored in the mobile terminal to the driver. For this, if different pieces of fingerprint information are input to the vehicle button and the button, only a restricted right is provided to the vehicle control device. This may prevent an access to unallowable information.

In a case that various terminals are arranged in the vehicle, a terminal which is to provide a user interface to the vehicle may be simply selected by a push input. In this case, a different right is provided according to whether fingerprints matches each other between a push input applied to the vehicle button and a push input applied to the terminal button. This may prevent terminal information from being provided to the vehicle against a user's will.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

### BRIEF DESCRIPTION OF THE DRAWINGS

The accompanying drawings, which are included to provide a further understanding of the invention and are incorporated in and constitute a part of this specification, illustrate exemplary embodiments and together with the description serve to explain the principles of the invention.

In the drawings:

FIG. 1 is a view illustrating an appearance of a vehicle according to an embodiment of the present disclosure;

FIG. 2 is a view in which a vehicle according to an embodiment of the present disclosure is seen at various angles;

FIGS. 3 and 4 are views illustrating an inside of a vehicle according to an embodiment of the present disclosure;

FIGS. 5 and 6 are views referred for explaining objects according to an embodiment of the present disclosure;

FIG. 7 is a block diagram referred for explaining a vehicle according to an embodiment of the present disclosure;

FIG. 8 is a conceptual view for explaining a vehicle control device and a mobile terminal according to an embodiment of the present invention;

FIG. 9 is a flowchart for explaining operations of the vehicle control device and the mobile terminal of FIG. 8;

FIG. 10 is a flowchart for explaining a control method of a mobile terminal;

FIGS. 11A to 11C are exemplary views for explaining the control method of FIG. 10 in more detail;

FIG. 12 is a flowchart for explaining an operation after a pairing;

FIGS. 13, 14A and 14B are exemplary views for explaining the operation of FIG. 12 in more detail;

FIG. 15 is a flowchart for explaining an operation when a vehicle control device and a mobile terminal are paired with each other;

FIG. 16 is a flowchart for explaining a control method of a vehicle control device;

FIG. 17 is a conceptual view for explaining a mobile terminal which performs a different operation according to an access right; and

FIG. 18 is a conceptual view for explaining a mobile terminal which performs a different operation according to a driving state of a vehicle.

### DETAILED DESCRIPTION

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

A vehicle according to an embodiment of the present invention may be understood as a conception including cars, motorcycles and the like. Hereinafter, the vehicle will be described based on a car.

The vehicle according to the embodiment of the present invention may be a conception including all of an internal combustion engine car having an engine as a power source, a hybrid vehicle having an engine and an electric motor as power sources, an electric vehicle having an electric motor as a power source, and the like.

In the following description, a left side of a vehicle refers to a left side in a driving direction of the vehicle, and a right side of the vehicle refers to a right side in the driving direction.

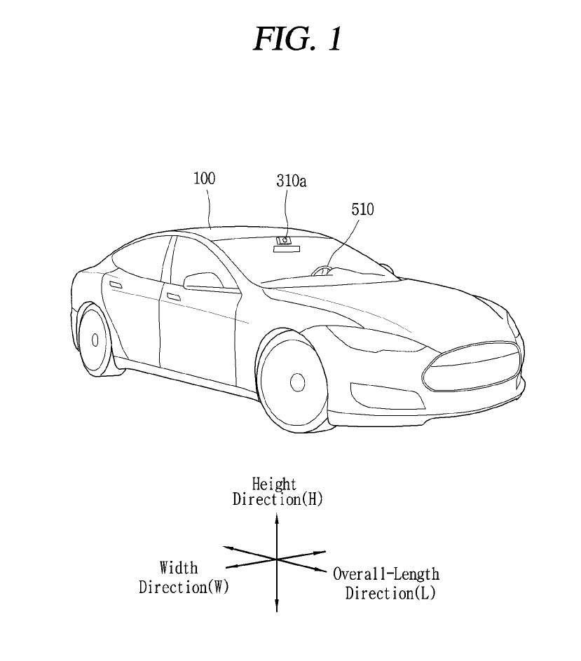

FIG. 1 is a view illustrating appearance of a vehicle in accordance with an embodiment of the present invention.

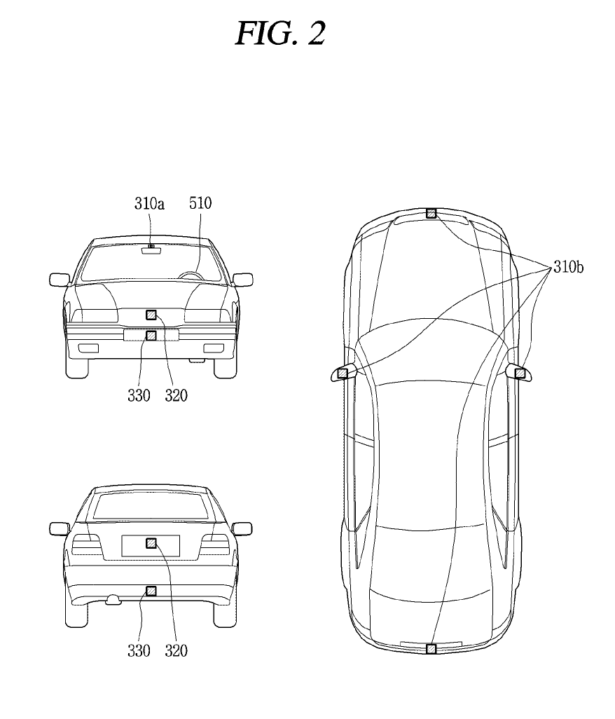

FIG. 2 is a view illustrating appearance of a vehicle at various angles in accordance with an embodiment of the present invention.

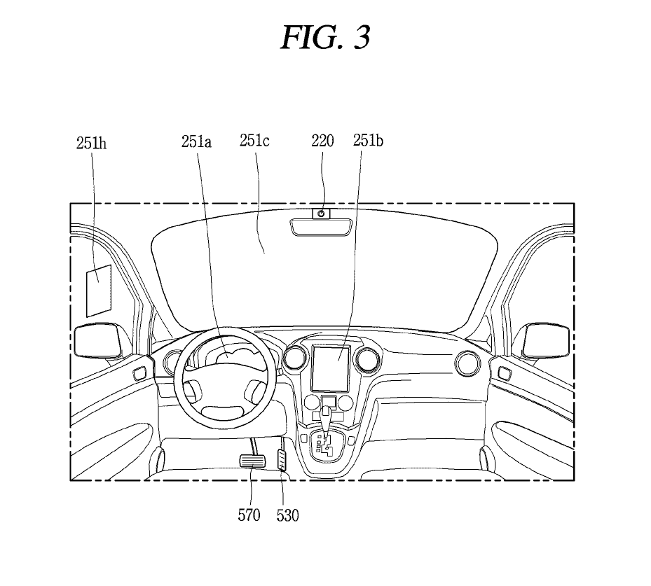

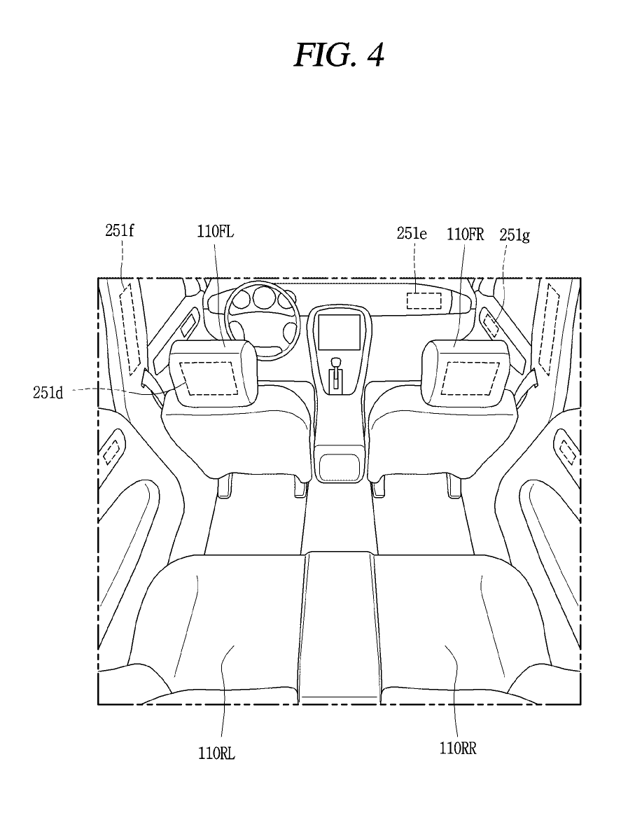

FIGS. 3 and 4 are views illustrating an inside of a vehicle in accordance with an embodiment of the present invention.

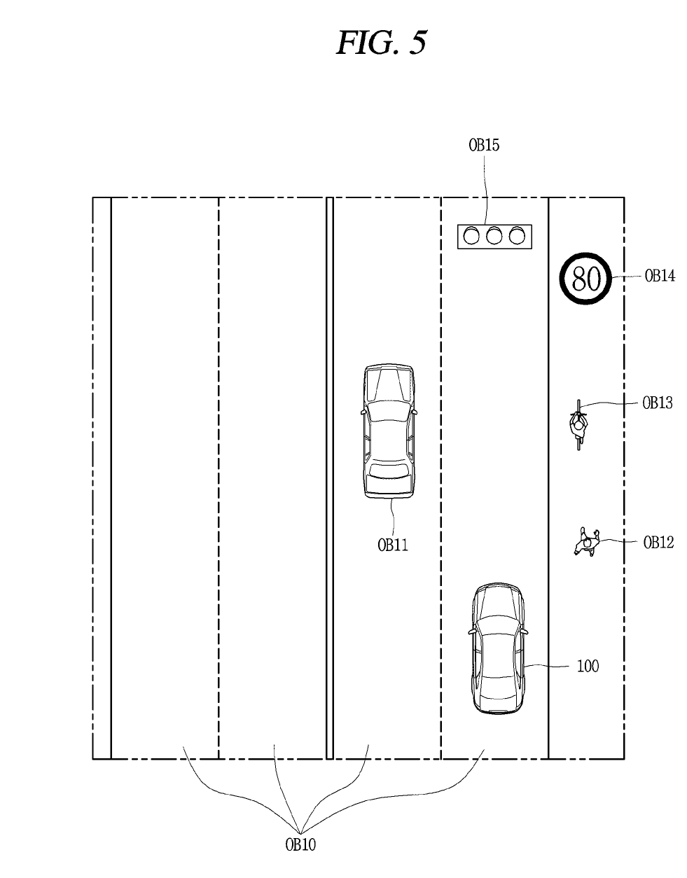

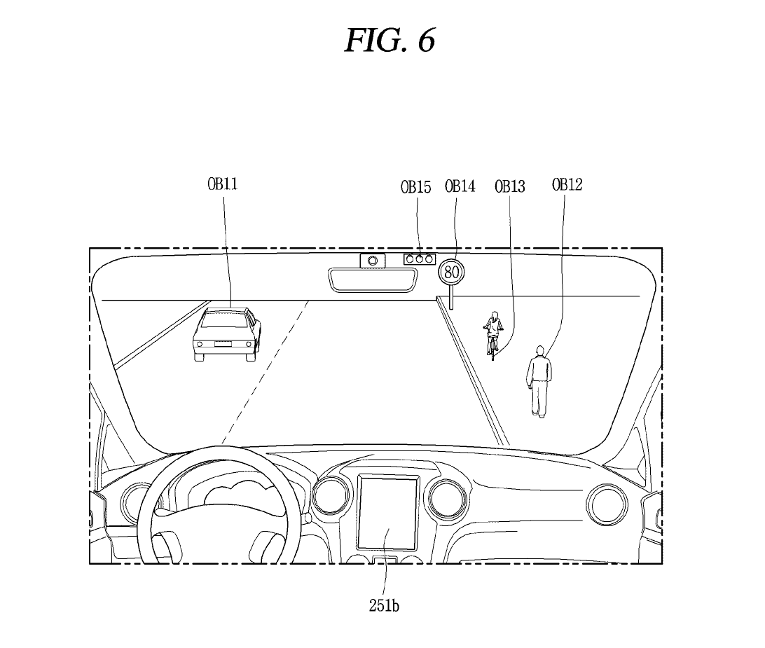

FIGS. 5 and 6 are reference views illustrating objects in accordance with an embodiment of the present invention.

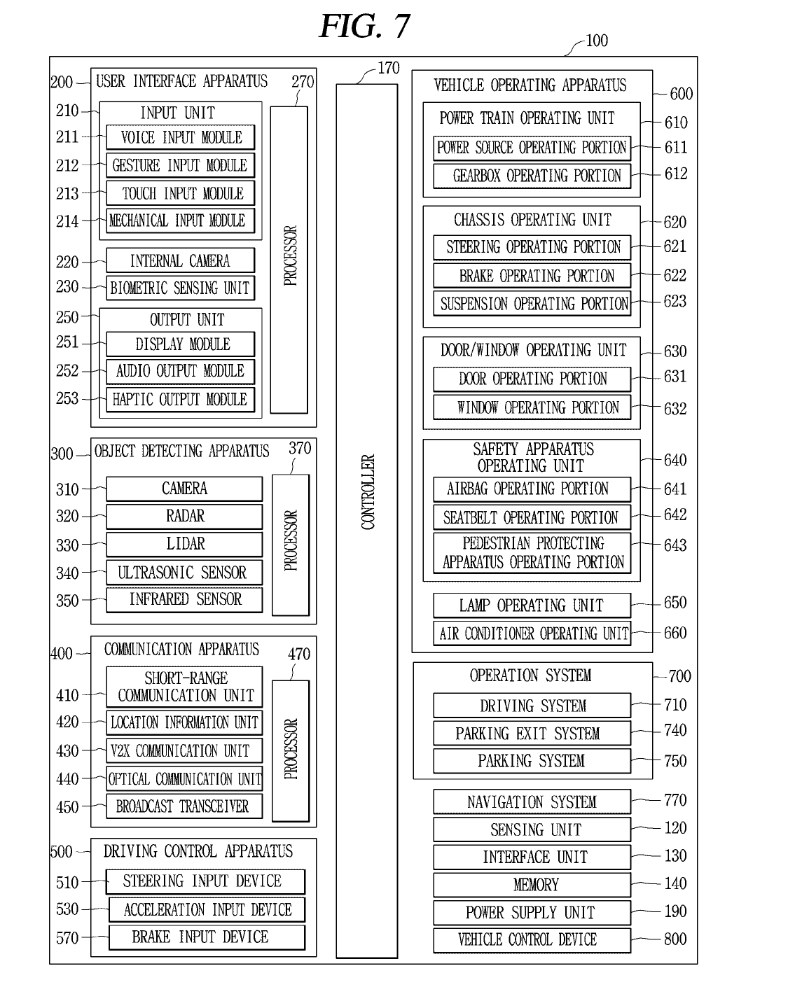

FIG. 7 is a block diagram illustrating a vehicle in accordance with an embodiment of the present invention

As illustrated in FIGS. 1 to 7, a vehicle 100 may include wheels turning by a driving force, and a steering apparatus 510 for adjusting a driving (ongoing, moving) direction of the vehicle 100.

The vehicle 100 may be an autonomous vehicle.

The vehicle 100 may be switched into an autonomous mode or a manual mode based on a user input.

For example, the vehicle may be converted from the manual mode into the autonomous mode or from the autonomous mode into the manual mode based on a user input received through a user interface apparatus 200.

The vehicle 100 may be switched into the autonomous mode or the manual mode based on driving environment information. The driving environment information may be generated based on object information provided from an object detecting apparatus 300.

For example, the vehicle 100 may be switched from the manual mode into the autonomous mode or from the autonomous module into the manual mode based on driving environment information generated in the object detecting apparatus 300.

In an example, the vehicle 100 may be switched from the manual mode into the autonomous mode or from the autonomous module into the manual mode based on driving environment information received through a communication apparatus 400.

The vehicle 100 may be switched from the manual mode into the autonomous mode or from the autonomous module into the manual mode based on information, data or signal provided from an external device.

When the vehicle 100 is driven in the autonomous mode, the autonomous vehicle 100 may be driven based on an operation system 700.

For example, the autonomous vehicle 100 may be driven based on information, data or signal generated in a driving system 710, a parking exit system 740 and a parking system 750.

When the vehicle 100 is driven in the manual mode, the autonomous vehicle 100 may receive a user input for driving through a driving control apparatus 500. The vehicle 100 may be driven based on the user input received through the driving control apparatus 500.

An overall length refers to a length from a front end to a rear end of the vehicle 100, a width refers to a width of the vehicle 100, and a height refers to a length from a bottom of a wheel to a roof. In the following description, an overall-length direction L may refer to a direction which is a criterion for measuring the overall length of the vehicle 100, a width direction W may refer to a direction that is a criterion for measuring a width of the vehicle 100, and a height direction H may refer to a direction that is a criterion for measuring a height of the vehicle 100.

As illustrated in FIG. 7, the vehicle 100 may include a user interface apparatus 200, an object detecting apparatus 300, a communication apparatus 400, a driving control apparatus 500, a vehicle operating apparatus 600, a operation system 700, a navigation system 770, a sensing unit 120, an interface unit 130, a memory 140, a controller 170 and a power supply unit 190.

According to embodiments, the vehicle 100 may include more components in addition to components to be explained in this specification or may not include some of those components to be explained in this specification.

The user interface apparatus 200 is an apparatus for communication between the vehicle 100 and a user. The user interface apparatus 200 may receive a user input and provide information generated in the vehicle 100 to the user. The vehicle 200 may implement user interfaces (UIs) or user experiences (UXs) through the user interface apparatus 200.

The user interface apparatus 200 may include an input unit 210, an internal camera 220, a biometric sensing unit 230, an output unit 250 and a processor 270.

According to embodiments, the user interface apparatus 200 may include more components in addition to components to be explained in this specification or may not include some of those components to be explained in this specification.

The input unit 200 may allow the user to input information. Data collected in the input unit 120 may be analyzed by the processor 270 and processed as a user's control command.

The input unit 210 may be disposed within the vehicle. For example, the input unit 200 may be disposed on one area of a steering wheel, one area of an instrument panel, one area of a seat, one area of each pillar, one area of a door, one area of a center console, one area of a headlining, one area of a sun visor, one area of a wind shield, one area of a window or the like.

The input unit 210 may include a voice input module 211, a gesture input module 212, a touch input module 213, and a mechanical input module 214.

The audio input module 211 may convert a user's voice input into an electric signal. The converted electric signal may be provided to the processor 270 or the controller 170.

The voice input module 211 may include at least one microphone.

The gesture input module 212 may convert a user's gesture input into an electric signal. The converted electric signal may be provided to the processor 270 or the controller 170.

The gesture input module 212 may include at least one of an infrared sensor and an image sensor for detecting the user's gesture input.

According to embodiments, the gesture input module 212 may detect a user's three-dimensional (3D) gesture input. To this end, the gesture input module 212 may include a light emitting diode outputting a plurality of infrared rays or a plurality of image sensors.

The gesture input module 212 may detect the user's 3D gesture input by a time of flight (TOF) method, a structured light method or a disparity method.

The touch input module 213 may convert the user's touch input into an electric signal. The converted electric signal may be provided to the processor 270 or the controller 170.

The touch input module 213 may include a touch sensor for detecting the user's touch input.

According to an embodiment, the touch input module 213 may be integrated with the display unit 251 so as to implement a touch screen. The touch screen may provide an input interface and an output interface between the vehicle 100 and the user.

The mechanical input module 214 may include at least one of a button, a dome switch, a jog wheel and a jog switch. An electric signal generated by the mechanical input module 214 may be provided to the processor 270 or the controller 170.

The mechanical input module 214 may be arranged on a steering wheel, a center fascia, a center console, a cockpit module, a door and the like.

The internal camera 220 may acquire an internal image of the vehicle. The processor 270 may detect a user's state based on the internal image of the vehicle. The processor 270 may acquire information related to the user's gaze from the internal image of the vehicle. The processor 270 may detect a user gesture from the internal image of the vehicle.

The biometric sensing unit 230 may acquire the user's biometric information. The biometric sensing module 230 may include a sensor for detecting the user's biometric information and acquire fingerprint information and heart rate information regarding the user using the sensor. The biometric information may be used for user authentication.

The output unit 250 may generate an output related to a visual, audible or tactile signal.

The output unit 250 may include at least one of a display module 251, an audio output module 252 and a haptic output module 253.

The display module 251 may output graphic objects corresponding to various types of information.

The display module 251 may include at least one of a liquid crystal display (LCD), a thin film transistor-LCD (TFT LCD), an organic light-emitting diode (OLED), a flexible display, a three-dimensional (3D) display and an e-ink display.

The display module 251 may be inter-layered or integrated with a touch input module 213 to implement a touch screen.

The display module 251 may be implemented as a head up display (HUD). When the display module 251 is implemented as the HUD, the display module 251 may be provided with a projecting module so as to output information through an image which is projected on a windshield or a window.

The display module 251 may include a transparent display. The transparent display may be attached to the windshield or the window.

The transparent display may have a predetermined degree of transparency and output a predetermined screen thereon. The transparent display may include at least one of a thin film electroluminescent (TFEL), a transparent OLED, a transparent LCD, a transmissive transparent display and a transparent LED display. The transparent display may have adjustable transparency.

Meanwhile, the user interface apparatus 200 may include a plurality of display modules 251a to 251g.

The display module 251 may be disposed on one area of a steering wheel, one area 521a, 251b, 251e of an instrument panel, one area 251d of a seat, one area 251f of each pillar, one area 251g of a door, one area of a center console, one area of a headlining or one area of a sun visor, or implemented on one area 251c of a windshield or one area 251h of a window.

The audio output module 252 converts an electric signal provided from the processor 270 or the controller 170 into an audio signal for output. To this end, the audio output module 252 may include at least one speaker.

The haptic output module 253 generates a tactile output. For example, the haptic output module 253 may vibrate the steering wheel, a safety belt, a seat 110FL, 110FR, 110RL, 110RR such that the user can recognize such output.

The processor 270 may control an overall operation of each unit of the user interface apparatus 200.

According to an embodiment, the user interface apparatus 200 may include a plurality of processors 270 or may not include any processor 270.

When the processor 270 is not included in the user interface apparatus 200, the user interface apparatus 200 may operate according to a control of a processor of another apparatus within the vehicle 100 or the controller 170.

Meanwhile, the user interface apparatus 200 may be called as a display apparatus for vehicle.

The user interface apparatus 200 may operate according to the control of the controller 170.

The object detecting apparatus 300 is an apparatus for detecting an object located at outside of the vehicle 100.

The object may be a variety of objects associated with driving (operation) of the vehicle 100.

Referring to FIGS. 5 and 6, an object O may include a traffic lane OB10, another vehicle OB11, a pedestrian OB12, a two-wheeled vehicle OB13, traffic signals OB14 and OB15, light, a road, a structure, a speed hump, a geographical feature, an animal and the like.

The lane OB01 may be a driving lane, a lane next to the driving lane or a lane on which another vehicle comes in an opposite direction to the vehicle 100. The lanes OB10 may be a concept including left and right lines forming a lane.

The another vehicle OB11 may be a vehicle which is moving around the vehicle 100. The another vehicle OB11 may be a vehicle located within a predetermined distance from the vehicle 100. For example, the another vehicle OB11 may be a vehicle which moves before or after the vehicle 100.

The pedestrian OB12 may be a person located near the vehicle 100. The pedestrian OB12 may be a person located within a predetermined distance from the vehicle 100. For example, the pedestrian OB12 may be a person located on a sidewalk or roadway.

The two-wheeled vehicle OB13 may refer to a vehicle (transportation facility) that is located near the vehicle 100 and moves using two wheels. The two-wheeled vehicle OB13 may be a vehicle that is located within a predetermined distance from the vehicle 100 and has two wheels. For example, the two-wheeled vehicle OB13 may be a motorcycle or a bicycle that is located on a sidewalk or roadway.

The traffic signals may include a traffic light OB15, a traffic sign OB14 and a pattern or text drawn on a road surface.

The light may be light emitted from a lamp provided on another vehicle. The light may be light generated from a streetlamp. The light may be solar light.

The road may include a road surface, a curve, an upward slope, a downward slope and the like.

The structure may be an object that is located near a road and fixed on the ground. For example, the structure may include a streetlamp, a roadside tree, a building, an electric pole, a traffic light, a bridge and the like.

The geographical feature may include a mountain, a hill and the like.

Meanwhile, objects may be classified into a moving object and a fixed object. For example, the moving object may be a concept including another vehicle and a pedestrian. The fixed object may be a concept including a traffic signal, a road and a structure.

The object detecting apparatus 300 may include a camera 310, a radar 320, a LiDAR 330, an ultrasonic sensor 340, an infrared sensor 350 and a processor 370.

According to an embodiment, the object detecting apparatus 300 may further include other components in addition to the components described, or may not include some of the components described.

The camera 310 may be located on an appropriate portion outside the vehicle to acquire an external image of the vehicle. The camera 310 may be a mono camera, a stereo camera 310a, an around view monitoring (AVM) camera 310b or a 360-degree camera.

For example, the camera 310 may be disposed adjacent to a front windshield within the vehicle to acquire a front image of the vehicle. Or, the camera 310 may be disposed adjacent to a front bumper or a radiator grill.

For example, the camera 310 may be disposed adjacent to a rear glass within the vehicle to acquire a rear image of the vehicle. Or, the camera 310 may be disposed adjacent to a rear bumper, a trunk or a tail gate.

For example, the camera 310 may be disposed adjacent to at least one of side windows within the vehicle to acquire a side image of the vehicle. Or, the camera 310 may be disposed adjacent to a side mirror, a fender or a door.

The camera 310 may provide an acquired image to the processor 370.

The radar 320 may include electric wave transmitting and receiving portions. The radar 320 may be implemented as a pulse radar or a continuous wave radar according to a principle of emitting electric waves. The radar 320 may be implemented in a frequency modulated continuous wave (FMCW) manner or a frequency shift Keyong (FSK) manner according to a signal waveform, among the continuous wave radar methods.

The radar 320 may detect an object in a time of flight (TOF) manner or a phase-shift manner through the medium of the electric wave, and detect a position of the detected object, a distance from the detected object and a relative speed with the detected object.

The radar 320 may be disposed on an appropriate position outside the vehicle for detecting an object which is located at a front, rear or side of the vehicle.

The LiDAR 330 may include laser transmitting and receiving portions. The LiDAR 330 may be implemented in a time of flight (TOF) manner or a phase-shift manner.

The LiDAR 330 may be implemented as a drive type or a non-drive type.

For the drive type, the LiDAR 330 may be rotated by a motor and detect object near the vehicle 100.

For the non-drive type, the LiDAR 330 may detect, through light steering, objects which are located within a predetermined range based on the vehicle 100. The vehicle 100 may include a plurality of non-drive type LiDARs 330.

The LiDAR 330 may detect an object in a TOP manner or a phase-shift manner through the medium of a laser beam, and detect a position of the detected object, a distance from the detected object and a relative speed with the detected object.

The LiDAR 330 may be disposed on an appropriate position outside the vehicle for detecting an object located at the front, rear or side of the vehicle.

The ultrasonic sensor 340 may include ultrasonic wave transmitting and receiving portions. The ultrasonic sensor 340 may detect an object based on an ultrasonic wave, and detect a position of the detected object, a distance from the detected object and a relative speed with the detected object.

The ultrasonic sensor 340 may be disposed on an appropriate position outside the vehicle for detecting an object located at the front, rear or side of the vehicle.

The infrared sensor 350 may include infrared light transmitting and receiving portions. The infrared sensor 340 may detect an object based on infrared light, and detect a position of the detected object, a distance from the detected object and a relative speed with the detected object.

The infrared sensor 350 may be disposed on an appropriate position outside the vehicle for detecting an object located at the front, rear or side of the vehicle.

The processor 370 may control an overall operation of each unit of the object detecting apparatus 300.

The processor 370 may detect an object based on an acquired image, and track the object. The processor 370 may execute operations, such as a calculation of a distance from the object, a calculation of a relative speed with the object and the like, through an image processing algorithm.

The processor 370 may detect an object based on a reflected electromagnetic wave which an emitted electromagnetic wave is reflected from the object, and track the object. The processor 370 may execute operations, such as a calculation of a distance from the object, a calculation of a relative speed with the object and the like, based on the electromagnetic wave.

The processor 370 may detect an object based on a reflected laser beam which an emitted laser beam is reflected from the object, and track the object. The processor 370 may execute operations, such as a calculation of a distance from the object, a calculation of a relative speed with the object and the like, based on the laser beam.

The processor 370 may detect an object based on a reflected ultrasonic wave which an emitted ultrasonic wave is reflected from the object, and track the object. The processor 370 may execute operations, such as a calculation of a distance from the object, a calculation of a relative speed with the object and the like, based on the ultrasonic wave.

The processor may detect an object based on reflected infrared light which emitted infrared light is reflected from the object, and track the object. The processor 370 may execute operations, such as a calculation of a distance from the object, a calculation of a relative speed with the object and the like, based on the infrared light.

According to an embodiment, the object detecting apparatus 300 may include a plurality of processors 370 or may not include any processor 370. For example, each of the camera 310, the radar 320, the LiDAR 330, the ultrasonic sensor 340 and the infrared sensor 350 may include the processor in an individual manner.

When the processor 370 is not included in the object detecting apparatus 300, the object detecting apparatus 300 may operate according to the control of a processor of an apparatus within the vehicle 100 or the controller 170.

The object detecting apparatus 300 may operate according to the control of the controller 170.

The communication apparatus 400 is an apparatus for performing communication with an external device. Here, the external device may be another vehicle, a mobile terminal or a server.

The communication apparatus 400 may perform the communication by including at least one of a transmitting antenna, a receiving antenna, and radio frequency (RF) circuit and RF device for implementing various communication protocols.

The communication apparatus 400 may include a short-range communication unit 410, a location information unit 420, a V2X communication unit 430, an optical communication unit 440, a broadcast transceiver 450 and a processor 470.

According to an embodiment, the communication apparatus 400 may further include other components in addition to the components described, or may not include some of the components described.

The short-range communication unit 410 is a unit for facilitating short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like.

The short-range communication unit 410 may construct short-range area networks to perform short-range communication between the vehicle 100 and at least one external device.

The location information unit 420 is a unit for acquiring position information. For example, the location information unit 420 may include a Global Positioning System (GPS) module or a Differential Global Positioning System (DGPS) module.

The V2X communication unit 430 is a unit for performing wireless communications with a server (Vehicle to Infra; V2I), another vehicle (Vehicle to Vehicle; V2V), or a pedestrian (Vehicle to Pedestrian; V2P). The V2X communication unit 430 may include an RF circuit implementing a communication protocol with the infra (V2I), a communication protocol between the vehicles (V2V) and a communication protocol with a pedestrian (V2P).

The optical communication unit 440 is a unit for performing communication with an external device through the medium of light. The optical communication unit 440 may include a light-emitting diode for converting an electric signal into an optical signal and sending the optical signal to the exterior, and a photodiode for converting the received optical signal into an electric signal.

According to an embodiment, the light-emitting diode may be integrated with lamps provided on the vehicle 100.

The broadcast transceiver 450 is a unit for receiving a broadcast signal from an external broadcast managing entity or transmitting a broadcast signal to the broadcast managing entity via a broadcast channel. The broadcast channel may include a satellite channel, a terrestrial channel, or both. The broadcast signal may include a TV broadcast signal, a radio broadcast signal and a data broadcast signal.

The processor 470 may control an overall operation of each unit of the communication apparatus 400.

According to an embodiment, the communication apparatus 400 may include a plurality of processors 470 or may not include any processor 470.

When the processor 470 is not included in the communication apparatus 400, the communication apparatus 400 may operate according to the control of a processor of another device within the vehicle 100 or the controller 170.

Meanwhile, the communication apparatus 400 may implement a display apparatus for a vehicle together with the user interface apparatus 200. In this instance, the display apparatus for the vehicle may be referred to as a telematics apparatus or an Audio Video Navigation (AVN) apparatus.

The communication apparatus 400 may operate according to the control of the controller 170.

The driving control apparatus 500 is an apparatus for receiving a user input for driving.

In a manual mode, the vehicle 100 may be operated based on a signal provided by the driving control apparatus 500.

The driving control apparatus 500 may include a steering input device 510, an acceleration input device 530 and a brake input device 570.

The steering input device 510 may receive an input regarding a driving (ongoing) direction of the vehicle 100 from the user. The steering input device 510 is preferably configured in the form of a wheel allowing a steering input in a rotating manner. According to some embodiments, the steering input device may also be configured in a shape of a touch screen, a touchpad or a button.

The acceleration input device 530 may receive an input for accelerating the vehicle 100 from the user. The brake input device 570 may receive an input for braking the vehicle 100 from the user. Each of the acceleration input device 530 and the brake input device 570 is preferably configured in the form of a pedal. According to some embodiments, the acceleration input device or the brake input device may also be configured in a shape of a touch screen, a touchpad or a button.

The driving control apparatus 500 may operate according to the control of the controller 170.

The vehicle operating apparatus 600 is an apparatus for electrically controlling operations of various devices within the vehicle 100.

The vehicle operating apparatus 600 may include a power train operating unit 610, a chassis operating unit 620, a door/window operating unit 630, a safety apparatus operating unit 640, a lamp operating unit 650, and an air-conditioner operating unit 660.

According to some embodiments, the vehicle operating apparatus 600 may further include other components in addition to the components described, or may not include some of the components described.

Meanwhile, the vehicle operating apparatus 600 may include a processor. Each unit of the vehicle operating apparatus 600 may individually include a processor.

The power train operating unit 610 may control an operation of a power train device.

The power train operating unit 610 may include a power source operating portion 611 and a gearbox operating portion 612.

The power source operating portion 611 may perform a control for a power source of the vehicle 100.

For example, upon using a fossil fuel-based engine as the power source, the power source operating portion 611 may perform an electronic control for the engine. Accordingly, an output torque and the like of the engine can be controlled. The power source operating portion 611 may adjust the engine output torque according to the control of the controller 170.

For example, upon using an electric energy-based motor as the power source, the power source operating portion 611 may perform a control for the motor. The power source operating portion 611 may adjust a rotating speed, a torque and the like of the motor according to the control of the controller 170.

The gearbox operating portion 612 may perform a control for a gearbox.

The gearbox operating portion 612 may adjust a state of the gearbox. The gearbox operating portion 612 may change the state of the gearbox into drive (forward) (D), reverse (R), neutral (N) or parking (P).

Meanwhile, when an engine is the power source, the gearbox operating portion 612 may adjust a locked state of a gear in the drive (D) state.

The chassis operating unit 620 may control an operation of a chassis device.

The chassis operating unit 620 may include a steering operating portion 621, a brake operating portion 622 and a suspension operating portion 623.

The steering operating portion 621 may perform an electronic control for a steering apparatus within the vehicle 100. The steering operating portion 621 may change a driving direction of the vehicle.

The brake operating portion 622 may perform an electronic control for a brake apparatus within the vehicle 100. For example, the brake operating portion 622 may control an operation of brakes provided at wheels to reduce speed of the vehicle 100.

Meanwhile, the brake operating portion 622 may individually control each of a plurality of brakes. The brake operating portion 622 may differently control braking force applied to each of a plurality of wheels.

The suspension operating portion 623 may perform an electronic control for a suspension apparatus within the vehicle 100. For example, the suspension operating portion 623 may control the suspension apparatus to reduce vibration of the vehicle 100 when a bump is present on a road.

Meanwhile, the suspension operating portion 623 may individually control each of a plurality of suspensions.

The door/window operating unit 630 may perform an electronic control for a door apparatus or a window apparatus within the vehicle 100.

The door/window operating unit 630 may include a door operating portion 631 and a window operating portion 632.

The door operating portion 631 may perform the control for the door apparatus. The door operating portion 631 may control opening or closing of a plurality of doors of the vehicle 100. The door operating portion 631 may control opening or closing of a trunk or a tail gate. The door operating portion 631 may control opening or closing of a sunroof.

The window operating portion 632 may perform the electronic control for the window apparatus. The window operating portion 632 may control opening or closing of a plurality of windows of the vehicle 100.

The safety apparatus operating unit 640 may perform an electronic control for various safety apparatuses within the vehicle 100.

The safety apparatus operating unit 640 may include an airbag operating portion 641, a seatbelt operating portion 642 and a pedestrian protecting apparatus operating portion 643.

The airbag operating portion 641 may perform an electronic control for an airbag apparatus within the vehicle 100. For example, the airbag operating portion 641 may control the airbag to be deployed upon a detection of a risk.

The seatbelt operating portion 642 may perform an electronic control for a seatbelt apparatus within the vehicle 100. For example, the seatbelt operating portion 642 may control passengers to be motionlessly seated in seats 110FL, 110FR, 110RL, 110RR using seatbelts upon a detection of a risk.

The pedestrian protecting apparatus operating portion 643 may perform an electronic control for a hood lift and a pedestrian airbag. For example, the pedestrian protecting apparatus operating portion 643 may control the hood lift and the pedestrian airbag to be open up upon detecting pedestrian collision.

The lamp operating unit 650 may perform an electronic control for various lamp apparatuses within the vehicle 100.

The air-conditioner operating unit 660 may perform an electronic control for an air conditioner within the vehicle 100. For example, the air-conditioner operating unit 660 may control the air conditioner to supply cold air into the vehicle when internal temperature of the vehicle is high.

The vehicle operating apparatus 600 may include a processor. Each unit of the vehicle operating apparatus 600 may individually include a processor.

The vehicle operating apparatus 600 may operate according to the control of the controller 170.

The operation system 700 is a system that controls various driving modes of the vehicle 100. The operation system 700 may include a driving system 710, a parking exit system 740 and a parking system 750.

According to embodiments, the operation system 700 may further include other components in addition to components to be described, or may not include some of the components to be described.

Meanwhile, the operation system 700 may include a processor. Each unit of the operation system 700 may individually include a processor.

According to embodiments, the operation system may be a sub concept of the controller 170 when it is implemented in a software configuration.

Meanwhile, according to embodiment, the operation system 700 may be a concept including at least one of the user interface apparatus 200, the object detecting apparatus 300, the communication apparatus 400, the vehicle operating apparatus 600 and the controller 170.

The driving system 710 may perform driving of the vehicle 100.

The driving system 710 may receive navigation information from a navigation system 770, transmit a control signal to the vehicle operating apparatus 600, and perform driving of the vehicle 100.

The driving system 710 may receive object information from the object detecting apparatus 300, transmit a control signal to the vehicle operating apparatus 600 and perform driving of the vehicle 100.

The driving system 710 may receive a signal from an external device through the communication apparatus 400, transmit a control signal to the vehicle operating apparatus 600, and perform driving of the vehicle 100.

The parking exit system 740 may perform an exit of the vehicle 100 from a parking lot.

The parking exit system 740 may receive navigation information from the navigation system 770, transmit a control signal to the vehicle operating apparatus 600, and perform the exit of the vehicle 100 from the parking lot.

The parking exit system 740 may receive object information from the object detecting apparatus 300, transmit a control signal to the vehicle operating apparatus 600 and perform the exit of the vehicle 100 from the parking lot.

The parking exit system 740 may receive a signal from an external device through the communication apparatus 400, transmit a control signal to the vehicle operating apparatus 600, and perform the exit of the vehicle 100 from the parking lot.

The parking system 750 may perform parking of the vehicle 100.

The parking system 750 may receive navigation information from the navigation system 770, transmit a control signal to the vehicle operating apparatus 600, and park the vehicle 100.

The parking system 750 may receive object information from the object detecting apparatus 300, transmit a control signal to the vehicle operating apparatus 600 and park the vehicle 100.

The parking system 750 may receive a signal from an external device through the communication apparatus 400, transmit a control signal to the vehicle operating apparatus 600, and park the vehicle 100.

The navigation system 770 may provide navigation information. The navigation information may include at least one of map information, information regarding a set destination, path information according to the set destination, information regarding various objects on a path, lane information and current location information of the vehicle.

The navigation system 770 may include a memory and a processor. The memory may store the navigation information. The processor may control an operation of the navigation system 770.

According to embodiments, the navigation system 770 may update prestored information by receiving information from an external device through the communication apparatus 400.

According to embodiments, the navigation system 770 may be classified as a sub component of the user interface apparatus 200.

The sensing unit 120 may sense a status of the vehicle. The sensing unit 120 may include a posture sensor (e.g., a yaw sensor, a roll sensor, a pitch sensor, etc.), a collision sensor, a wheel sensor, a speed sensor, a tilt sensor, a weight-detecting sensor, a heading sensor, a gyro sensor, a position module, a vehicle forward/backward movement sensor, a battery sensor, a fuel sensor, a tire sensor, a steering sensor by a turn of a handle, a vehicle internal temperature sensor, a vehicle internal humidity sensor, an ultrasonic sensor, an illumination sensor, an accelerator position sensor, a brake pedal position sensor, and the like.

The sensing unit 120 may acquire sensing signals with respect to vehicle-related information, such as a posture, a collision, an orientation, a position (GPS information), an angle, a speed, an acceleration, a tilt, a forward/backward movement, a battery, a fuel, tires, lamps, internal temperature, internal humidity, a rotated angle of a steering wheel, external illumination, pressure applied to an accelerator, pressure applied to a brake pedal and the like.

The sensing unit 120 may further include an accelerator sensor, a pressure sensor, an engine speed sensor, an air flow sensor (AFS), an air temperature sensor (ATS), a water temperature sensor (WTS), a throttle position sensor (TPS), a TDC sensor, a crank angle sensor (CAS), and the like.

The interface unit 130 may serve as a path allowing the vehicle 100 to interface with various types of external devices connected thereto. For example, the interface unit 130 may be provided with a port connectable with a mobile terminal, and connected to the mobile terminal through the port. In this instance, the interface unit 130 may exchange data with the mobile terminal.

Meanwhile, the interface unit 130 may serve as a path for supplying electric energy to the connected mobile terminal. When the mobile terminal is electrically connected to the interface unit 130, the interface unit 130 supplies electric energy supplied from a power supply unit 190 to the mobile terminal according to the control of the controller 170.

The memory 140 is electrically connected to the controller 170. The memory 140 may store basic data for units, control data for controlling operations of units and input/output data. The memory 140 may be a variety of storage devices, such as ROM, RAM, EPROM, a flash drive, a hard drive and the like in a hardware configuration. The memory 140 may store various data for overall operations of the vehicle 100, such as programs for processing or controlling the controller 170.

According to embodiments, the memory 140 may be integrated with the controller 170 or implemented as a sub component of the controller 170.

The controller 170 may control an overall operation of each unit of the vehicle 100. The controller 170 may be referred to as an Electronic Control Unit (ECU).

The power supply unit 190 may supply power required for an operation of each component according to the control of the controller 170. Specifically, the power supply unit 190 may receive power supplied from an internal battery of the vehicle, and the like.

At least one processor and the controller 170 included in the vehicle 100 may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro controllers, microprocessors, and electric units performing other functions.

Hereinafter, a vehicle control device 800 provided at the vehicle 100 will be explained in more detail.

The vehicle control device 800 is provided at the vehicle 100, and may be an independent device detachably installed at the vehicle or may be a component of the vehicle 100 by being integrally installed at the vehicle 100.

Hereinafter, for convenience, it is assumed that the vehicle control device 800 has a separate configuration independent from the controller 170 of the vehicle 100. However, this is merely an embodiment of the present invention, and an operation and a control method of the vehicle control device 800 explained in this specification may be also executable by the controller 170 of the vehicle 100. That is, an operation and/or a control method executed by a processor 830 of the vehicle control device 800 may be also executable by the controller 170 of the vehicle 100.

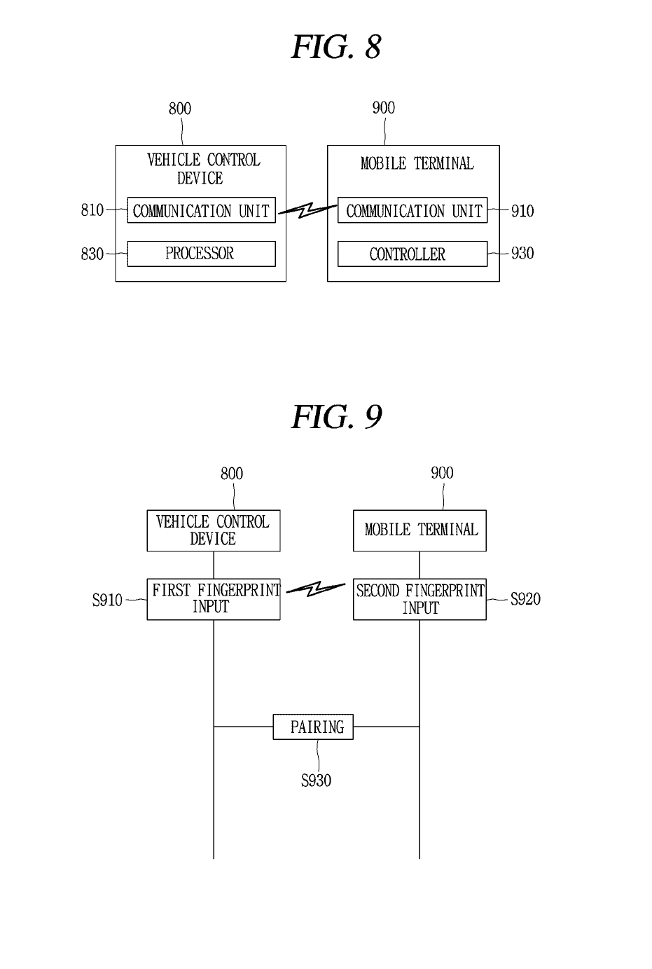

FIG. 8 is a conceptual view for explaining a vehicle control device and a mobile terminal according to an embodiment of the present invention.

Referring to FIG. 8, the vehicle control device 800 includes a communication unit 810 and a processor 830.

The communication unit 810 is configured to communicate with the various components explained with reference to FIG. 7. For instance, the communication unit 810 may receive various types of information provided through a controller area network (CAN). As another example, the communication unit 810 may communicate with all devices which can perform communication, such as a vehicle, a mobile terminal, a server, and other vehicle. This may be referred to as a vehicle to everything (V2X) communication. The V2X communication may be defined as a technique to exchange or share information such as a traffic situation, by communicating with other vehicle with respect to roadway infrastructures during a driving.

The communication unit 810 is configured to perform communication with one or more displays provided at the vehicle 100.

Further, the communication unit 810 may receive information on driving of a vehicle, from most devices provided at the vehicle 100. Information transmitted to the vehicle control device 800 from the vehicle 100 is called ‘vehicle driving information’.

The vehicle driving information includes vehicle information and surrounding information. Based on a frame of the vehicle 100, information on the inside of the vehicle may be defined as vehicle information, and information on the outside of the vehicle may be defined as surrounding information.

The vehicle information means information on a vehicle itself. For instance, the vehicle information may include a driving speed of a vehicle, a driving direction, an acceleration, an angular speed, a position (GPS), a weight, the number of passengers inside a vehicle, a braking force of a vehicle, a maximum braking force of a vehicle, an air pressure of each wheel, a centrifugal force applied to a vehicle, a driving mode of a vehicle (an autonomous driving mode or a manual driving mode), a parking mode of a vehicle (an autonomous parking mode, an automatic parking mode, or a manual parking mode), information on whether there is a passenger in a vehicle, information on the passenger, etc.

The surrounding information means information on another object positioned within a predetermined range on the basis of a vehicle, and information on the outside of a vehicle. For instance, the surrounding information may be a state of a road surface on which a vehicle is running (frictional force), weather, a distance from a front (or rear) vehicle, a relative speed of a front (or rear) vehicle, a bending modulus of a curve when a lane on which a vehicle is running has the curve, a peripheral brightness of a vehicle, information on an object which exists within a reference region (predetermined region) on the basis of a vehicle, information whether an object enters or departs the predetermined region, information on whether a user exists around a vehicle, information on the user (e.g., information on whether the user is an authorized user or not), etc.

The surrounding information may include ambient light, a temperature, a sun position, information on an object which exists nearby (a person, other vehicle, a sign, etc.), a type of a road surface on which a vehicle is running, a terrain feature, line information, lane information, and information required in autonomous driving/autonomous parking/automatic parking/manual parking mode.

The surrounding information may further include a distance from an object which exists near the vehicle to the vehicle 100, a collision probability, a type of the object, a parking lot where the vehicle can be parked, an object for identifying a parking lot (e.g., a parking lane, a string, other vehicle, a wall, etc.) and so on.

The vehicle driving information is not limited to the aforementioned examples, and may include all information generated from components provided at the vehicle 100.

The processor 830 is configured to control one or more displays provided at the vehicle 100 by using the communication unit 810.

More specifically, the processor 830 may determine whether at least one of a plurality of preset conditions is satisfied based on vehicle driving information received through the communication unit 810. The processor 830 may differently control the one or more displays according to the satisfied condition.

With regards to the preset condition, the processor 830 may sense occurrence of an event from electronic components provided at the vehicle 100 and/or applications, and may determine whether the sensed event satisfies the preset condition. Here, the processor 830 may also sense occurrence of an event, from information received through the communication unit 810.

The application is a concept including a widget, a home launcher, etc., and means all types of programs which can be driven at the vehicle 100. Thus, the application may be a program which performs a web browser, a video play, a message transception (transmission and reception), a schedule management, and an update function.

Further, the application may include at least one of a Forward Collision Warning (FCW), a Blind Spot Detection (BSD), a Lane Departure Warning (LDW), a Pedestrian Detection (PD), a Curve Speed Warning (CSW) and a Turn By Turn navigation (TBT).

For instance, an event occurrence may be a missed call, an application to be updated, an arrived message, a start on, a start off, an autonomous driving on/off, a pressed state of an LCD awake key, an alarm, an incoming call, a missed notification, etc.

As another example, the event occurrence may be generation of an alarm set to an advanced driver assistance system (ADAS), and a case when a function set to the ADAS is performed. For instance, the event occurrence may correspond to a case where a forward collision warning occurs, a case where a blind spot detection occurs, a case where a lane departure warning occurs, a case where a lane keeping assist warning occurs, and a case where an autonomous emergency braking is performed.

As another example, the event occurrence may correspond to a case where a forward gear is changed into a backward gear, a case where an acceleration larger than a predetermined value occurs, a case where a deceleration larger than a predetermined value occurs, a case where a power system is changed into a motor from an internal combustion engine, or a case where a power system is changed into an internal combustion engine from a motor.

Further, the event occurrence may correspond to a case where various ECUs provided at the vehicle 100 perform specific functions.

If an occurred event satisfies a preset condition, the processor 830 controls the communication unit 810 such that information corresponding to the condition is displayed on the one or more displays.

For hardware implementation, the embodiments may be implemented by using at least one of ASICs (application specific integrated circuits), DSPs (digital signal processors), DSPDs (digital signal processing devices), PLDs (programmable logic devices), FPGAs (field programmable gate arrays), processors, controllers, micro-controllers, microprocessors, and electric units which perform other functions. In some cases, the embodiments may be implemented by the processor 830.

For software implementation, embodiments such as procedures or functions may be implemented together with a separate software module for performing at least one function or operation. A software code may be implemented by a software application written in a proper program language. The software code may be stored in a memory (not shown), and may be executable by the processor 830.

The vehicle control device 800 may perform communication with a mobile terminal 900 positioned within a predetermined range on the basis of the vehicle 100.

The mobile terminal 100 in this specification may include a portable phone, a smart phone, a laptop computer, a digital broadcasting terminal, a Personal Digital Assistant (PDA), a Portable Multimedia Player (PMP), a navigation, etc.

The mobile terminal 900 includes a communication unit 910 and a controller 930.

The communication unit 910 may include one or more modules for wireless communication between the mobile terminal 900 and a wireless communication system, or between the mobile terminal 900 and a network where the mobile terminal 900 is positioned. For instance, the communication unit 910 may include a broadcasting receiving module, a mobile communication module, a wireless internet module, a short-range communication module, a position information module, etc.

The controller 930 controls an entire operation of the mobile terminal. For instance, the controller 930 performs a related control and process for voice communication, data communication, a video call, etc.

The vehicle control device 800 establishes a wired/wireless connection to the mobile terminal 900 through the communication unit 810, and performs data communication.

The mobile terminal 900 includes a display. For differentiation from a vehicle display 851 to be explained later, the display included in the mobile terminal 900 is referred to as ‘terminal display 951’.

The vehicle display 851 is formed to have a larger screen than the terminal display 951. However, there is a predetermined restriction on information output according to the law. For instance, when the vehicle is running, a play screen of a video stored in the memory or received in real-time from a server cannot be displayed, and the number of letters which can be displayed may be limited to less than a predetermined number. However, when the vehicle is stopped or is running with a speed lower than a predetermined value, such restrictions disappear, and a driver may be provided with various information by using the vehicle display 851.

The vehicle display 851 may include at least one of a dashboard display, a head up display (HUD), a center information display (CID), and a center fascia display 240.

The vehicle control device 800 establishes a wired/wireless connection to the mobile terminal 900 through the communication unit 810, and performs data communication.

Once a connection between the vehicle control device 800 and the mobile terminal 100 is established, the vehicle control device 800 may transmit information on the vehicle display 851, to the mobile terminal 900. For instance, information required for the mobile terminal 900 to use the vehicle display 851, such as a size of the vehicle display 851, a resolution and a screen ratio, may be transmitted to the mobile terminal 900 from the vehicle control device 800.

The mobile terminal 900 may execute at least one of a plurality of installed applications, and may transmit relevant information to the vehicle control device 800 such that an execution screen of the executed application may be output to the vehicle display 851.

Since the terminal display 951 and the vehicle display 851 have different resolutions and screen ratios, a terminal execution screen output to the terminal display 951 and a vehicle execution screen output to the vehicle display 851 may be different from each other.

Further, since the vehicle execution screen is subject to the law unlike the terminal execution screen, there is a restriction on information output according to the law. For instance, the number of letters included in a screen may be limited to a value less than a maximum value, or including a video in the vehicle execution screen may be prohibited. The reason is in order to prevent occurrence of an accident due to a driver's attention dispersion by the vehicle execution screen.

The vehicle execution screen may further include a new graphic object not included in the terminal execution screen. The new graphic object corresponds to a function to execute an application installed at the vehicle control device 800 rather than the mobile terminal 900. For instance, the new graphic object may correspond to a function to control a volume of an audio output unit installed at the vehicle, a function to output a vehicle home screen stored in the vehicle, or a function to operate electronic components of the vehicle.

In case of a specific application, the mobile terminal 900 may store the terminal execution screen expected to be output to the terminal display 951, and the vehicle execution screen expected to be output to the vehicle display 851.

In this case, the mobile terminal 900 may select the terminal execution screen when outputting an execution screen of a specific application to the terminal display 951, and may select the vehicle execution screen when transmitting to the vehicle so as to output to the vehicle display 851.

Alternatively, the mobile terminal 900 may create a new vehicle execution screen by using information received from the vehicle control device 800, i.e., information related to the vehicle display 851. For instance, the terminal execution screen expected to be output to the terminal display 951 may be edited based on information related to the vehicle display 851.

The vehicle control device 800 outputs screen information to the vehicle display 851 based on information received from the mobile terminal 900. The information output to the vehicle display 851 corresponds to an execution screen of an application installed at the mobile terminal 900. In order to output the execution screen to the vehicle display 851, the mobile terminal 900 may transmit the execution screen to the vehicle control device 800, or may transmit a source code, an image, a video, RGB information, etc. for outputting the execution screen.

The vehicle control device 800 may generate the vehicle driving information by combining information sensed by at least two sensors provided at the vehicle. Here, the vehicle driving information means all types of vehicle-related information sensed by the sensing unit.

The vehicle driving information includes a driving mode of the vehicle 100, and the driving mode includes an autonomous driving mode and a manual driving mode.

The autonomous driving mode means a state that at least one of an acceleration and a moving direction of the vehicle 100 is changeable by a program provided at the vehicle control device 800 and/or the mobile terminal 900, without a manipulation of a driver sitting on a driver's seat of the vehicle.

The autonomous driving mode corresponds to an embodiment of the present invention, and may be variously changed according to an embodiment. For instance, even when the vehicle 100 is running through a remote control, the autonomous driving mode may be defined.

The manual driving mode is defined as a state not an autonomous driving mode, and is changed according to a definition of the autonomous driving mode. For instance, if the autonomous driving mode is defined as a state that both an acceleration and a moving direction of the vehicle 100 are changeable by a program, the manual driving mode may be defined as a state that at least one of an acceleration and a moving direction of the vehicle 200 is changeable by a driver's input.

The mobile terminal 900 communicates with the vehicle control device 800 having the vehicle display 851 by using the communication unit, and may receive driving information generated from the vehicle control device 800. The mobile terminal 900 may perform a different control based on the driving information received from the vehicle control device 800.

Hereinafter, an operation of the vehicle control device 800 and the mobile terminal 900 will be explained in more detail with reference to the attached drawings.

FIG. 9 is a flowchart for explaining operations of the vehicle control device and the mobile terminal of FIG. 8.

Before explaining the operations of FIG. 9, a button 960 provided at the mobile terminal 900 and a vehicle button 1110 provided at the vehicle 100 will be explained.

The button 960 may be formed to scan a fingerprint of a user's finger which applies a push input. More specifically, a fingerprint scanner module is mounted to one surface of the button 960, thereby recognizing a fingerprint of a finger contacting the button 960. The button 960 is formed to be slidable by the push input, thereby pressurizing a switch. The controller 930 senses the push input when the switch is pressurized, thereby processing a corresponding control command.

However, the present invention is not limited to the structure. For instance, the push button may be replaced by a touch button. More specifically, the fingerprint scanner module may be arranged on an upper surface of the touch button. Accordingly, a push input through the push button may be replaced by a touch input through the touch button in the following descriptions.

The fingerprint scanner module may be utilized as a functional key related to power on/off. For instance, if the button 960 is pushed in an off state of the mobile terminal, a fingerprint recognition is performed as a power is supplied to the fingerprint scanner module. The mobile terminal 900 determines whether a recognized fingerprint corresponds to a user's pre-stored fingerprint, and turns on the mobile terminal and performs a booting operation if the recognized fingerprint corresponds to the user's pre-stored fingerprint. As a power-on command of the mobile terminal is performed through two stages (power-on of the fingerprint scanner and power on of the mobile terminal), power consumption may be reduced. That is, a security function through a fingerprint recognition may be provided to a power-on operation. In this case, the fingerprint scanner module may be turned off together with the body of the mobile terminal.

Further, in this case, if the power on-operation and the booting operation of the mobile terminal are completed, the terminal display 951 may immediately enter a home screen page without entering a lock screen, because the mobile terminal is in an on state.

If the recognized fingerprint does not correspond to the user's pre-stored fingerprint, the power on-operation and the booting operation of the mobile terminal are stopped. In this case, the mobile terminal 900 may output a warning message indicating that the recognized fingerprint does not correspond to the user's pre-stored fingerprint. The warning message may be implemented as a lighting effect provided to a front surface of the mobile terminal for a predetermined time, or may be implemented as an effect sound.

As another example, if a push input is applied to the button 960 in a lock mode where a lock screen is output to the terminal display 951, the lock screen may be converted into a home screen page as the locked state is released. In this case, the button 960 may be a hot key for releasing the locked state.

However, the locked state is released only when a fingerprint scanner performs a fingerprint recognition with respect to an object contacting the button for a push input, and when a recognized fingerprint corresponds to the user's pre-stored fingerprint. During the fingerprint recognition, a notification message indicating that the fingerprint recognition is being performed may be output to the display unit of the mobile terminal.

The vehicle button 1110 which performs the same function as the button 960 of the mobile terminal 900 may be arranged at the vehicle 100. More specifically, the vehicle button 1110 is arranged to be overlapped with the fingerprint scanner at one point of a steering wheel. The vehicle button 1110 may be utilized as a functional key related to starting or turning off the starting of the vehicle 100, or may be used as a hot key for releasing a locked state of the vehicle 100.

If a first fingerprint input (or a first push input) is applied to the vehicle button 1110, the vehicle control device 800 may perform one of functions executable in the vehicle 100, in correspondence to the first fingerprint input. For instance, the vehicle control device 800 may execute a vehicle application installed at the vehicle 100, or may release a locked state of the vehicle 100.

If a second fingerprint input (or a second push input) is applied to the button 960 of the mobile terminal 900, the mobile terminal 900 may perform one of functions executable in the mobile terminal 900, in correspondence to the second fingerprint input. For instance, the mobile terminal 900 may execute a terminal application installed at the mobile terminal 900, or may release a locked state of the mobile terminal 900.

If the first fingerprint input is applied to the vehicle button 1110 and the second fingerprint input is applied to the button 960 with a predetermined time, the vehicle control device 800 and the mobile terminal 900 may control their communication units 810, 930 for establishment of a preset type of connection. That is, if a preset condition is satisfied, a preset type of connection is established between the vehicle control device 800 and the mobile terminal 900.

The preset condition may be a case where the mobile terminal 900 is positioned in the vehicle 100, a first push input is applied to the vehicle button 1110 of the vehicle, and a second push input is applied to the button 960 within a predetermined time. The predetermined time may be variously changed according to an embodiment, and may be a short time less than one minute which can be regarded as the same time.

If the preset condition is not satisfied, each device performs its own function. However, if the preset condition is satisfied, each device may perform an operation for a reciprocal connection rather than its own function.

A state that the vehicle control device 800 and the mobile terminal 900 are connected to each other by the first and second fingerprint inputs is called ‘pairing’.

More specifically, the vehicle control device 800 may generate first fingerprint information in response to the first fingerprint input, and may broadcast the generated first fingerprint information or may transmit the generated first fingerprint information to the mobile terminal 900 positioned in the vehicle 100 (S910).

The mobile terminal 900 may generate second fingerprint information in response to the second fingerprint input, and may broadcast the generated second fingerprint information or may transmit the generated second fingerprint information to the vehicle control device 800 (S930).

The vehicle control device 800 and the mobile terminal 900 perform different functions according to whether fingerprint information is received from another party within the predetermined time.

If fingerprint information is received from another party within the predetermined time, a pairing is performed (S930).

Further, each device may determine a type of a screen to be displayed on the vehicle display 851 according to whether the first fingerprint information matches the second fingerprint information, and may control the vehicle display 851 to display the determined screen.

If fingerprint information is not received from another party within the predetermined time, no pairing is performed and a unique function of each device is performed.

If a user wishes to use the mobile terminal 900, he or she may execute a function set to the mobile terminal 900 by applying a push input to the button 960. On the other hand, if a user wishes to use the vehicle control device 800, he or she may execute a function set to the vehicle control device 800 by applying a push input to the vehicle button 1110. If a user wishes to use both of the vehicle control device 800 and the mobile terminal 900 by pairing, he or she may apply a first push input to the vehicle button 1110, and may apply a second push input to the button 960.

Once the pairing is performed, an execution screen of an application installed at the mobile terminal 900 may be displayed on the vehicle terminal 851 through the vehicle control device 800. The vehicle button 1110 may be operated as an input device with respect to the mobile terminal 900.

Hereinafter, an operation when a pairing is performed will be explained in more detail.

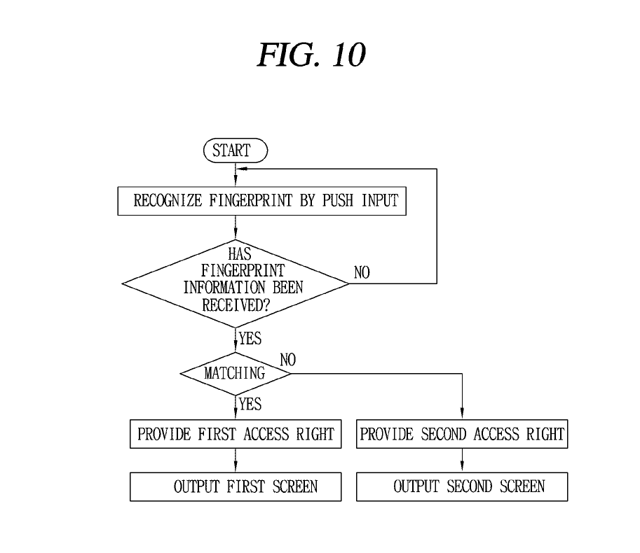

FIG. 10 is a flowchart for explaining a control method of the mobile terminal.

Firstly, the controller 930 performs a fingerprint recognition by a push input, through the fingerprint scanner arranged to be overlapped with the button 960 (S1010).

Then, the controller 930 determines whether fingerprint information is received or not within a predetermined time, in correspondence to the push input. The predetermined time may be counted from a time point when the push input has been applied, or may be counted from a time point when the fingerprint information has been received. Alternatively, the predetermined time may be counted from a starting time point included in the fingerprint information.

If the fingerprint information is not received within the predetermined time, a terminal function corresponding to the push input is performed regardless of the vehicle control device 800. On the other hand, if the fingerprint information is received within the predetermined time, it is determined whether a fingerprint recognized by the fingerprint scanner matches fingerprint information received from the vehicle. That is, it is determined whether the first fingerprint information matches the second fingerprint information.

The first fingerprint information is generated by a first push input for pushing the vehicle button within the predetermined time.

A different operation may be performed according to a matching state. More specifically, the controller 930 may determine a type of a screen to be displayed on the vehicle display 851, according to whether a fingerprint recognized by the fingerprint scanner matches fingerprint information received from the vehicle. And the controller 930 controls the communication unit 910 such that the determined screen is displayed on the vehicle display 851.

If the recognized fingerprint matches the received fingerprint information, the controller 930 provides a first access right to the vehicle 100 (S1020). And the controller 930 controls the communication unit 910 such that a first screen is displayed on the vehicle display 851 (S1022).

On the other hand, if the recognized fingerprint does not match the received fingerprint information, the controller 930 provides a second access right having a lower level than the first access right, to the vehicle 100 (S1030). And the controller 930 controls the communication unit 910 such that a second screen rather than the first screen is displayed on the vehicle display 851 (S1032).

The access right means a right to execute an application installed at the mobile terminal 900 or to use information stored in the memory of the mobile terminal 900, by the vehicle control device 800. The vehicle control device 800 may execute an application based on information of the mobile terminal 900, only within a range of an allowed right.

If the first fingerprint information matches the second fingerprint information, a driver of the vehicle 100 matches a user of the mobile terminal 900. Thus, a highest right to access the mobile terminal 900 is provided to the vehicle control device 800.

On the other hand, if the first fingerprint information does not match the second fingerprint information, the driver of the vehicle 100 does not match the user of the mobile terminal 900. Thus, a right to access the mobile terminal 900 with a right of a limited level is provided to the vehicle control device 800.

The access right may be checked through a vehicle home screen displayed on the vehicle display 851. The reason is because the first screen is displayed when the first access right is provided, and the second screen is displayed when the second access right is provided.

The mobile terminal 900 includes a memory for storing a plurality of applications. The first screen includes an icon of an application included in a first group among pre-stored applications, and the second screen includes an icon of an application included in a second group among the pre-stored applications.

Since the second access right has a lower level than the second access right, the second screen may include a smaller number of icons than the first screen. That is, the number of applications which are usable on the vehicle display 851 of the vehicle 100 among applications installed at the mobile terminal 900, may be variable according to an access right.

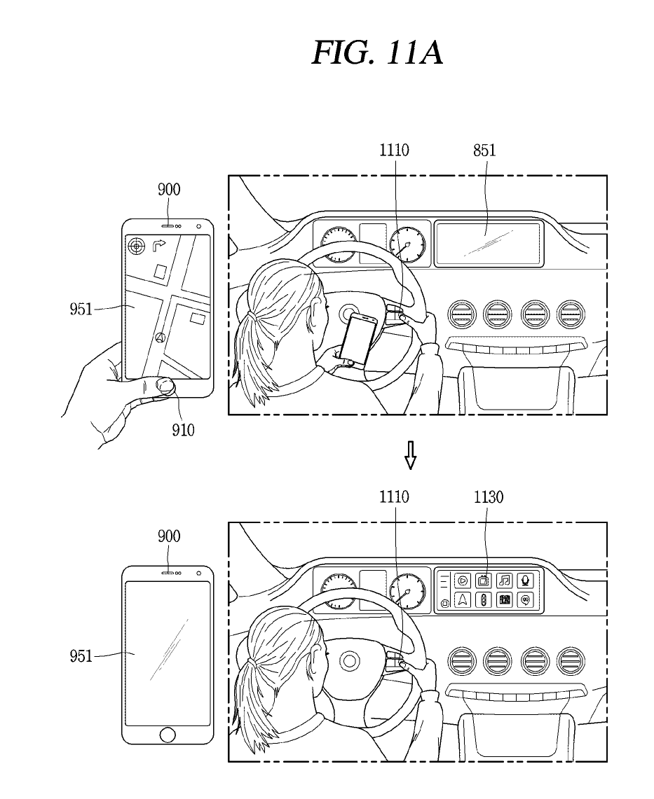

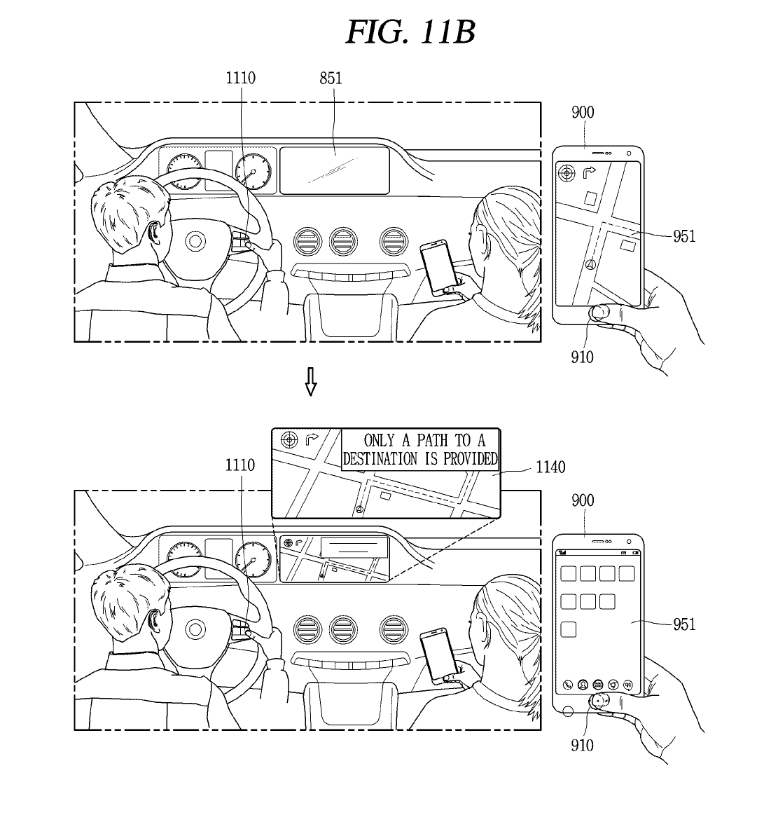

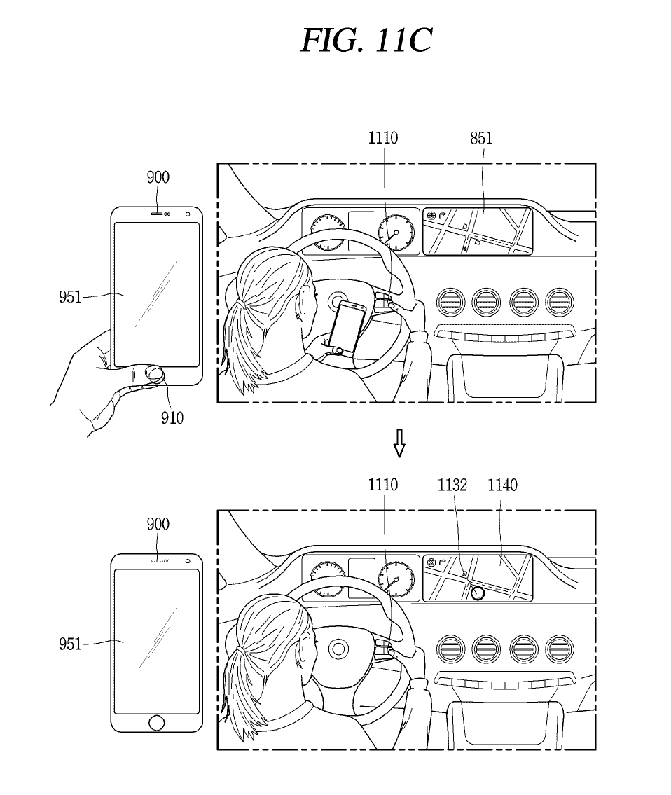

FIGS. 11A to 11C are exemplary views for explaining the control method of FIG. 10 in more detail.

As shown in FIG. 11A, a first user may apply a first fingerprint input to the vehicle button 1110 and may apply a second fingerprint input to the button 960 within a predetermined time, thereby pairing the mobile terminal 900 and the vehicle control device 800 with each other.

Since the first fingerprint input matches the second fingerprint input, the mobile terminal 900 provides a first access right to the vehicle 100, and controls the communication unit 910 such that the first screen 1130 is displayed on the vehicle display 851.

While receiving road guidance information by using the display of the mobile terminal 900, the user may get on the vehicle 100 and may input the first and second push inputs to the button 960 and the vehicle button 1110.

In this case, as the mobile terminal 900 and the vehicle control device 800 are paired with each other, a first access right to the mobile terminal 900 is provided to the vehicle control device 800. And the first screen set to the mobile terminal 900 is displayed on the vehicle display 851 through the communication unit 910.

The first screen 1130 may include a home button 1132 set to display a home screen page. If a touch input is applied to an icon included in the first screen, an application corresponding to the icon is executed, and an execution screen of the application is displayed on the vehicle display 851 as the first screen disappears. The home button 1132 is displayed on the execution screen, and the user may access the mobile terminal 900 by using the home button 1132.

Once a pairing is performed, the terminal display 951 may be converted into an off state from an on state, and the vehicle display 851 may be converted into an off state from an on state.

As shown in FIG. 11B, a first user may apply a first push input to the vehicle button 1110, and a second user may apply a second push input to the button 960.

In this case, the first fingerprint information does not match the second fingerprint information, and the controller 930 may provide the second access right rather than the first access right to the vehicle 100. And the controller 930 controls the communication unit 910 such that the second screen 1140 rather than the first screen 1130 is displayed on the vehicle display 851.

For instance, an owner of the vehicle 100 may request a driving of the vehicle 100 to a deputy driver. In this case, there are needs that the owner does not wish to provide all information stored in the mobile terminal 900 to the driver. For this, if different fingerprint information is applied to the vehicle button 1110 and the button 960, only a restricted right is provided to the vehicle control device 800. This may prevent an access to prohibited information.

If a pairing is performed while road guidance information is displayed on the mobile terminal 900, the road guidance information may be transferred from the terminal display 951 to the vehicle display 851. That is, the road guidance information may disappear from the terminal display 951, and may be displayed on the vehicle display 851.

A type of a screen displayed on the vehicle display 851 when a pairing is performed, i.e., a type of the second screen may be variable according to a type of an application being executed at the mobile terminal 900, or a type of an execution screen being displayed on the terminal display 851.

Even if the first screen 1130 includes the home button 1132, the second screen 1140 may not include the home button 1132. Since the home button 1132 can be used as a hot key for accessing the mobile terminal 100, a user's access to the home screen page may be prevented by restricting a display.

In a state that one of the first and second access rights has been provided to the vehicle 100, if a new push input is applied to the button 960, the controller 930 may update the one into the other according to whether a fingerprint recognized by the fingerprint scanner matches new fingerprint information received from the vehicle 100.

For instance, in a state that the second access right is provided as shown in FIG. 11B, the existing driver may get off and a user sitting on another seat may sit on a driver's seat, as shown in FIG. 11C. Then, new push inputs may be applied to the button 960 and the vehicle button 1110. The controller 930 may determine a matching state based on the new push inputs, and may perform a different control.

In a matched state, the controller 930 may update the second access right to the first access right. And the controller 930 may display the home button 1132 on the vehicle display 851 on which an execution screen is being displayed. When a touch input is applied to the home button 1132, the first screen 1130 aforementioned with reference to FIG. 11A may be displayed.

In a non-matched state, the controller 930 may maintain the second access right and may maintain a display state of the second screen.

A user may simply pair the vehicle control device 800 and the mobile terminal 900 with each other, and may conveniently set a different right according to a driver.

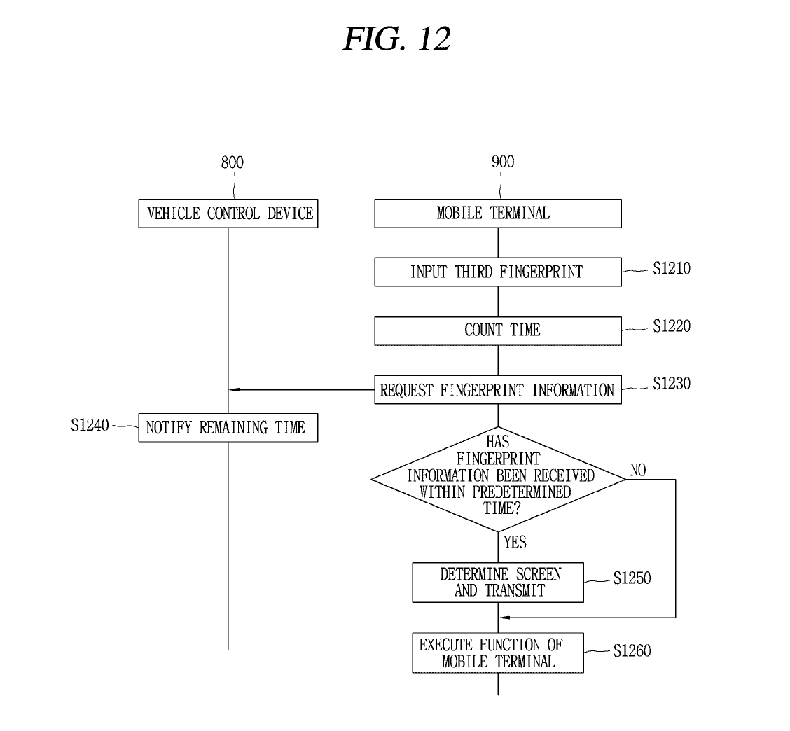

An operation after a paring will be explained in more detail with reference to FIG. 12.

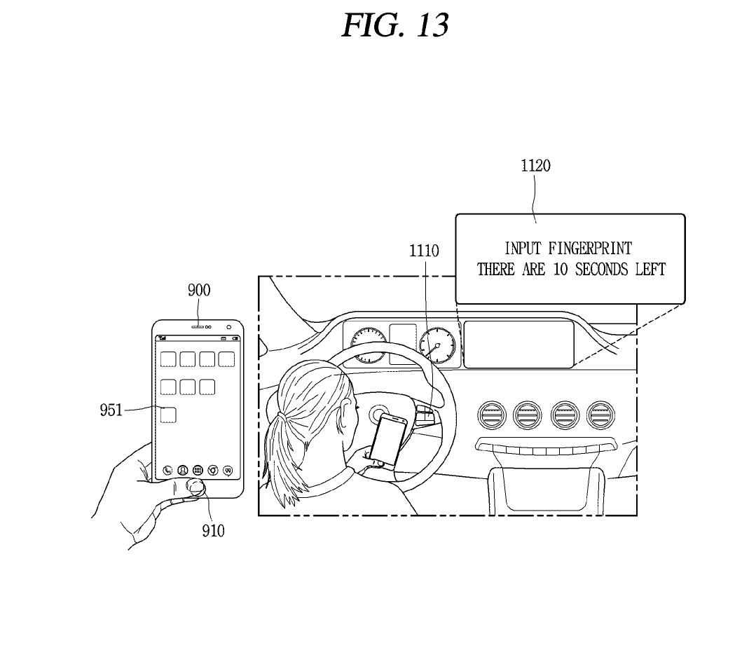

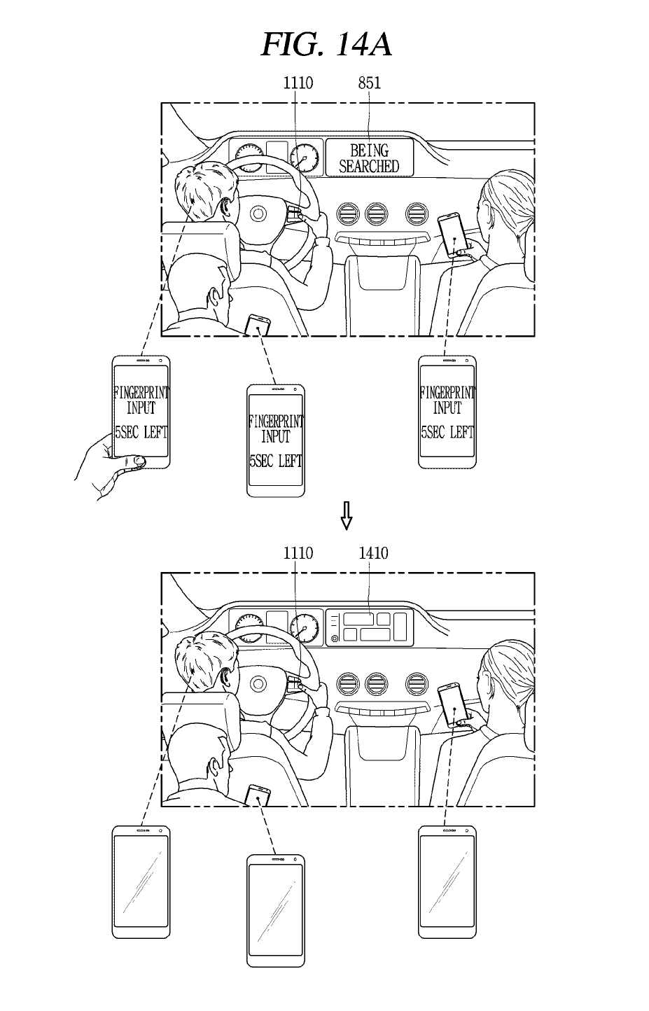

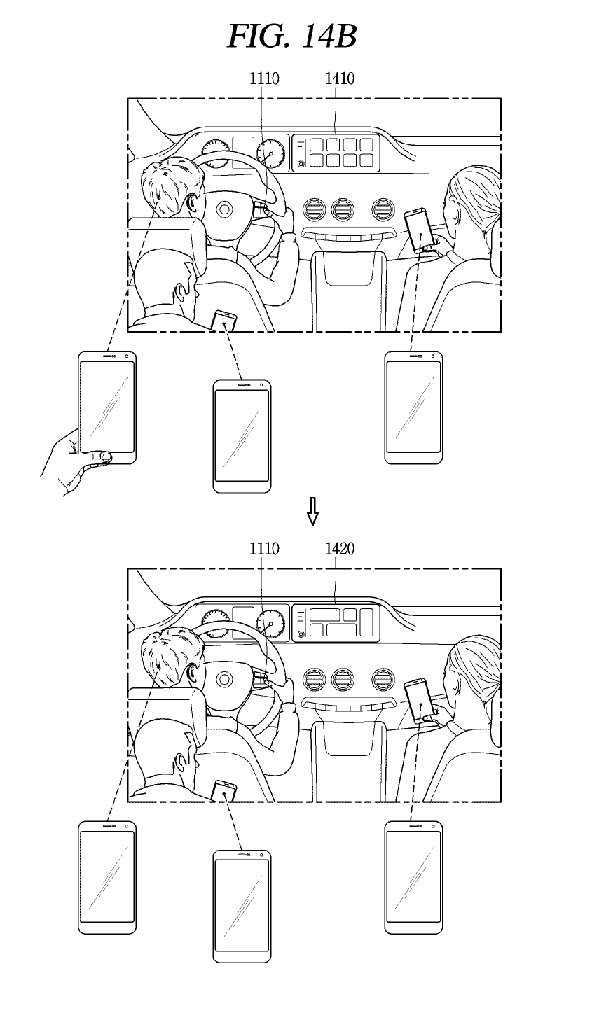

FIG. 12 is a flowchart for explaining an operation of the mobile terminal which interworks with the vehicle control device, and FIGS. 13, 14A and 14B are exemplary views for explaining the operation of FIG. 12 in more detail.

In a paired state, a third fingerprint input may be input through the button 960 (S1210).

In this case, the controller 930 may determine whether the third fingerprint input is an input for controlling the mobile terminal 900, or an input for controlling the vehicle control device 800.

The controller 930 may start a time counting from a time point when the third fingerprint input has been applied (S1220). This is in order to calculate a predetermined time for determining a condition to selectively execute a vehicle function or a terminal function.

The vehicle function may mean a function to change a screen displayed on the vehicle display 851, and the terminal function may mean a function to change a screen displayed on the terminal display 951.

That is, if one of the first push input to the vehicle button 1110 and the second push input to the button 960 is applied, the counting for the predetermined time is started. If the other input is not applied within the predetermined time, no pairing may be performed, or the existing pairing may be released. In this case, a predetermined screen is not displayed on the vehicle display 851.

And the controller 930 may request fingerprint information to the vehicle control device 800 (S1230). If a push input is applied to the button 960, the controller 930 may control the communication unit 910 such that a message requesting the fingerprint information may be transmitted to the vehicle.

The vehicle control device 800 may notify a time left up to the predetermined time, in response to the fingerprint information request (S1240).

If one of the first and second push inputs is applied, the controller 930 may control the communication unit 910 such that guidance information indicating the predetermined time may be displayed on the vehicle display 851 and/or the terminal display 951.

As shown in FIG. 13, if a new push input is applied to the button 910, a predetermined time (e.g., 10 seconds) may be counted, and guidance information indicating the time being counted may be displayed on the vehicle display 851. The guidance information may include a position of the vehicle button 1110 requiring a fingerprint input, a text requesting for a fingerprint input, a video, image information.

If fourth fingerprint information is received from the vehicle control device 800 within the predetermined time, the mobile terminal 900 may determine a screen according to whether third fingerprint information corresponding to the third fingerprint input matches the fourth fingerprint information. Then, the mobile terminal 900 may control the communication unit 910 such that the determined screen may be displayed on the vehicle display 851. Further, the controller 930 may update a right provided to the vehicle 100 according to whether the third fingerprint information matches the fourth fingerprint information.

On the other hand, if the fourth fingerprint information is not received within the predetermined time, the controller 930 executes a terminal function rather than a vehicle function (S1260).

Here, the fourth fingerprint information means fingerprint information generated by a new push input applied to the vehicle button 1110 within the predetermined time.

As shown in FIGS. 14A and 14B, a plurality of terminals may be positioned in the vehicle 100.

If a new push input is applied to the vehicle button 1110, the processor 830 may request fingerprint information to the plurality of terminals positioned in the vehicle 100.

At least one terminal having received the fingerprint information request may output guidance information indicating a predetermined time required for a fingerprint input. For instance, a message “There are 5 seconds left up to a fingerprint input.” may be displayed on the terminal display.

A new push input may be applied to a home button provided on at least one of the plurality of terminals. For instance, a new push input may be applied to a home button of a second terminal 1420 among first to third terminals. The second terminal 1420 transmits the inputted fingerprint information to the vehicle control device 800.

Then, the operations aforementioned with reference to FIGS. 2 and 3 are performed between the vehicle control device 800 and the second terminal 1420. That is, the vehicle control device 800 and the second terminal 1420 are paired with each other, and a different screen may be displayed according to whether fingerprint information of the vehicle control device 800 matches fingerprint information of the second terminal 1420.

For instance, in a paired state with the first terminal 1410, the vehicle control device 800 may be paired with the second terminal 1420 rather than the first terminal 1410 by new push inputs. Then, a screen provided from the second terminal 1420, not a screen provided from the first terminal 1410, is displayed on the vehicle display 851.

After the predetermined time lapses, the first to third terminals 1410˜1430 terminate the output of the guidance information.

As shown in FIG. 14B, in a paired state with the second terminal 1420, the vehicle control device 800 may be connected to the third terminal 1430 by new push inputs. Here, notification information indicating the paired terminal may be output to the vehicle display 851.

In a case that various terminals are arranged in the vehicle, a terminal which is to provide a user interface to the vehicle may be simply selected by a push input. In this case, a different right is provided according to whether fingerprints matches each other between a push input applied to the vehicle button and a push input applied to the terminal button. This may prevent terminal information from being provided to the vehicle against a user's will.

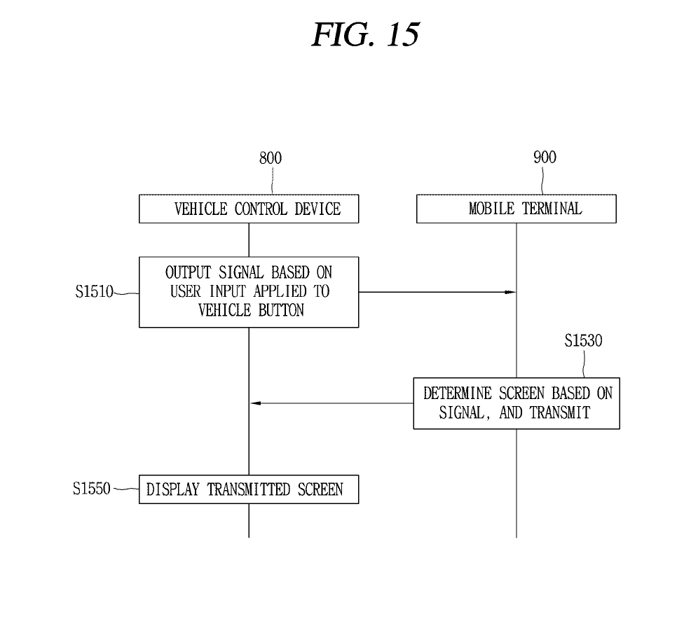

FIG. 15 is a flowchart for explaining an operation when the vehicle control device and the mobile terminal are paired with each other.

The vehicle control device 800 outputs a signal based on a user input applied to the vehicle button 1110 (S1510). For instance, a first signal may be output if the vehicle button 1110 is pressurized in a first manner, and a second signal may be output if the vehicle button 1110 is pressurized in a second manner. After the pairing is performed, the mobile terminal 900 receives the user input applied to the vehicle button 1110, through the communication unit 910.

The mobile terminal 900 may determine a screen based on the signal received from the vehicle control device 800, and may transmit relevant information to the vehicle control device 800 such that the determined screen may be displayed on the vehicle display 851 (S1530).

The mobile terminal 900 controls the communication unit 830 such that a different screen may be displayed on the vehicle display 851 according to the user input. For instance, if the vehicle button 830 is pressurized one time, a vehicle home screen including icons executable through the vehicle control device 800 may be displayed. On the other hand, if the vehicle button 830 is consecutively pressurized two times, at least one execution screen of an application executed through the vehicle control device 800 may be displayed. If the vehicle button 830 is pressurized for a predetermined time, a voice recognition function to receive a voice command may be executed.

The vehicle control device 800 displays the transmitted screen on the vehicle display 851 (S1550).

A user may use the vehicle button 1110 mounted to the vehicle 100 as an input means for controlling the mobile terminal 900, as well as a means for controlling the vehicle 100. This may enhance a user convenience.

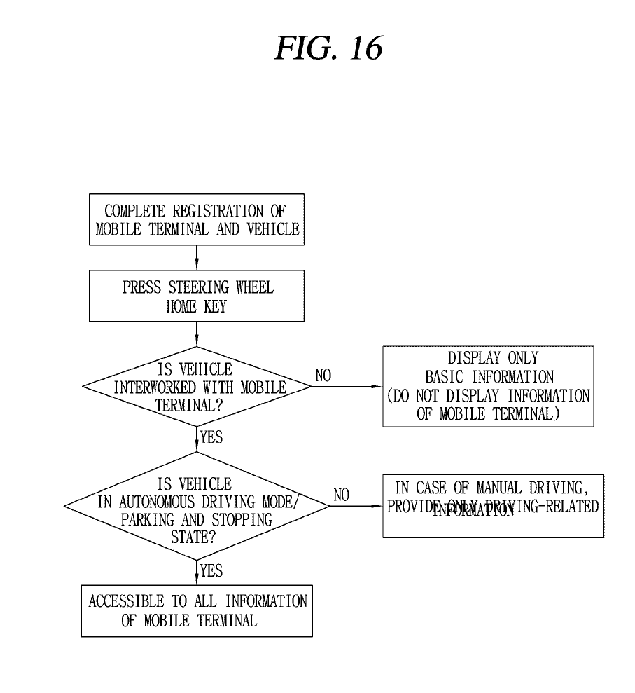

FIG. 16 is a conceptual view for explaining the mobile terminal which performs a different operation according to an access right.

If a user input is applied to the vehicle button 1110 provided at the vehicle 100 in a state that the vehicle 100 has a first access right, the controller 930 may execute a first function. On the other hand, if the user input is applied to the vehicle button 1110 in a state that the vehicle 100 has a second access right, the controller 930 may execute a second function different from the first function.

That is, even if the same user input is applied, a different function may be executed according to a right provided to the vehicle 100.

For instance, while an execution screen of an application is displayed in a paired state, a push input to pressurize the vehicle button 1110 one time may be applied. If the push input is applied in a provided state of a first access right, a function to display a home screen on the vehicle display 851 may be executed. If the push input is applied in a provided state of a second access right, a previous screen display function may be executed. A function provided to the vehicle button 1110 is variable according to an access right.

Even if the same user input is applied, a different screen is displayed according to an access right provided to the vehicle. This may enhance a user convenience. Further, an unauthorized user's access to a home screen page may be prevented.

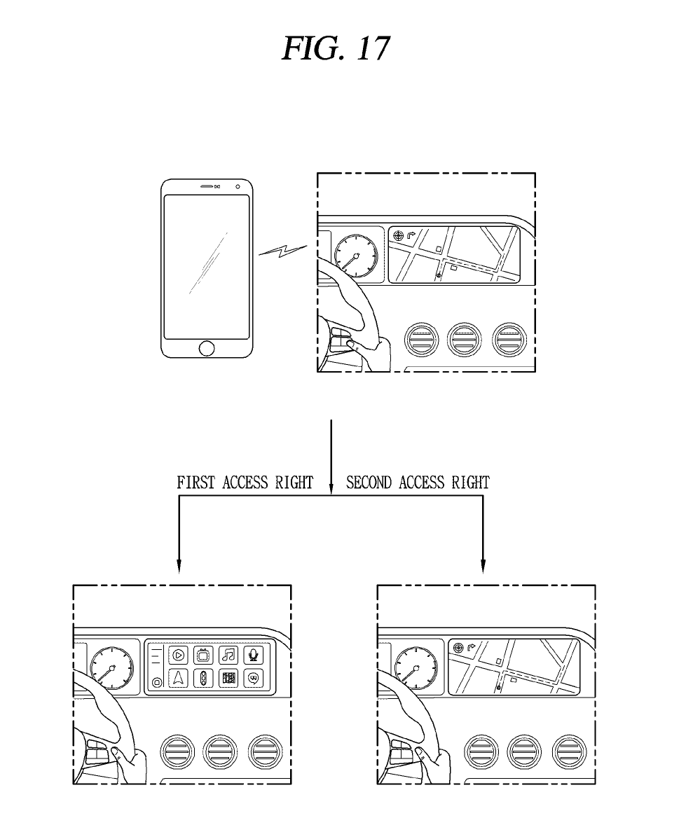

FIG. 17 is a conceptual view for explaining the mobile terminal which performs a different operation according to a driving state of the vehicle.

The controller 930 may control the communication unit 910 such that a different screen may be displayed on the display 851 according to whether the vehicle 100 is in a manual driving state or an autonomous driving state, even if the same input is applied to the vehicle button 930.

For instance, while an execution screen of an application is displayed in a paired state, a push input to pressurize the vehicle button 1110 one time may be applied. In this case, the controller 930 may determine a home screen to be displayed on the vehicle display 851.

More specifically, the controller 930 may determine a driving state of the vehicle 100 based on vehicle driving information received from the vehicle control device 800. And the controller 930 may control the communication unit 910 such that a manual driving home screen or an autonomous driving home screen may be displayed according to the driving state of the vehicle 100.

In a manual driving state, an icon size and/or a text size may be restricted and an executable application may be restricted such that conditions required by law may be satisfied.

Even if the same user input is applied, a different screen is displayed according to a vehicle driving state. This may enhance a user convenience more.

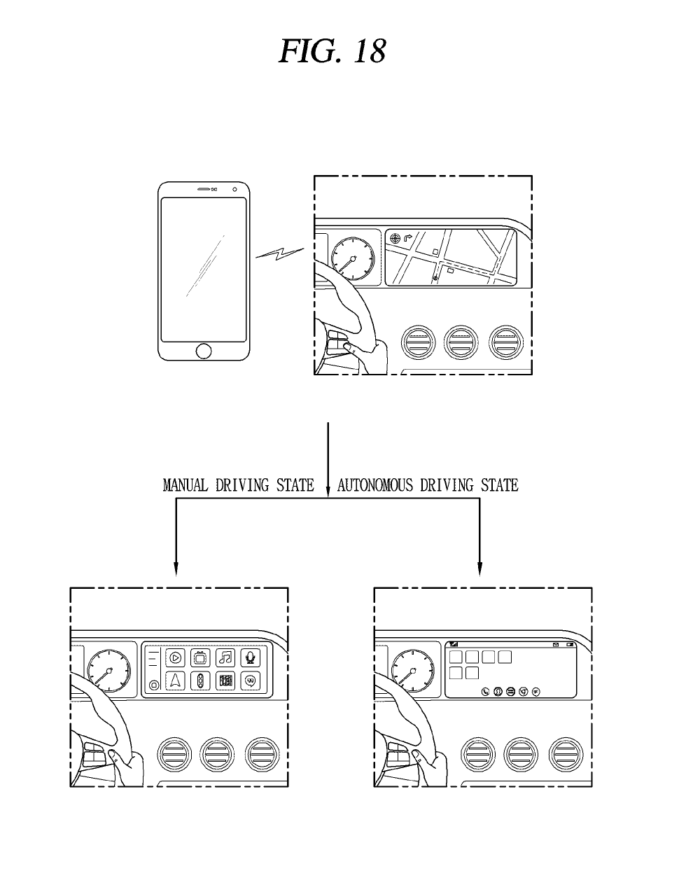

FIG. 18 is a flowchart for explaining a control method of the vehicle control device.

The mobile terminal and the vehicle are paired with each other by first and second push inputs, and complete a registration. Then, the vehicle button 1110 disposed at the steering wheel is operated as a home key.

More specifically, the controller 930 executes a first function if a user input is applied to the vehicle button 1110 mounted to the vehicle 100, in a state that a first access right is provided to the vehicle 100. On the other hand, the controller 930 executes a second function different from the first function, if the user input is applied to the vehicle button 1110 in a state that a second access right is provided to the vehicle 100.

As shown in FIG. 18, if the vehicle button 1110 is pressurized one time in a non-paired state with the mobile terminal 900, a screen preset to the vehicle control device 800 may be displayed. The screen is not received from the mobile terminal 900, but is stored in the memory of the vehicle control device 800.

In case of an autonomous driving in a paired state with the mobile terminal 900, the vehicle control device 800 can access all information stored in the mobile terminal 900. However, in case of a manual driving, the vehicle control device 800 can access limited information allowed to be usable during a manual driving.

The operations of the controller 930 aforementioned with reference to FIGS. 10 and 12 may be also executable by the processor 830 of the vehicle control device 800.

More specifically, the processor 830 may determine a type of a screen to be displayed on the vehicle display 851 or the terminal display 951 according to whether first fingerprint information matches second finger print information, and may output the determined screen.

If the first fingerprint information matches the second finger print information, the first access right may be provided to a user. On the other hand, if the recognized fingerprint does not match the received fingerprint information, the second access right having a lower level than the first access right may be provided to the user.

If the first access right is provided, the vehicle may be started or the starting of the vehicle may be turned off, and a locked state of a storage box (a glove compartment) provided at the vehicle 100 may be turned on or off. Further, a function to pay with a payment means provided at the vehicle 100 may be also executable.

If the second access right is provided, a function allowed only to the first access right is not executable. For instance, a locked state of the storage box cannot be released, and a payment function cannot be executed. Only a function provided to the second access right can be executed. For instance, a function to turn on or off an air conditioner, and a function to turn on or off a music player may be set to the second access right.

That is, the number of functions executable in the vehicle 100 by a user may be variable according to an access right.

The processor 830 executes a first function if a user input is applied to the vehicle button, in a state that the vehicle is provided with the first access right. On the other hand, the processor 830 executes a second function different from the first function, if the user input is applied to the vehicle button in a state that the vehicle is provided with the second access right.

Further, if the recognized fingerprint matches the received fingerprint information, the processor 830 controls the communication unit 810 such that a first screen may be displayed on the vehicle display 851. On the other hand, if the recognized fingerprint does not match the received fingerprint information, the processor 830 controls the communication unit 810 such that a second screen rather than the first screen may be displayed on the vehicle display 851.

The present invention may be applicable to the vehicle 100 provided with the vehicle control device 800 aforementioned with reference to FIGS. 8 to 18.

The foregoing present invention may be implemented as codes readable by a computer on a medium written by the program (or applications or software). The computer-readable media may include all kinds of recording devices in which data readable by a computer system is stored. Examples of the computer-readable media may include ROM, RAM, CD-ROM, magnetic tape, floppy disk, and optical data storage device, and the like, and also include a device implemented in the form of a carrier wave (for example, transmission via the Internet). In addition, the computer may include a processor or controller. Accordingly, the detailed description thereof should not be construed as restrictive in all aspects but considered as illustrative. The scope of the invention should be determined by reasonable interpretation of the appended claims and all changes that come within the equivalent scope of the invention are included in the scope of the invention.

What is claimed is:

1. A mobile terminal, comprising:
a user interface configured to receive user input;
a fingerprint scanner that is located adjacent to the user interface and that is configured to recognize a fingerprint from the user input received through the user interface;
a communication unit that is configured to communicate with a processor of a vehicle that includes a display, wherein the processor is configured to control the vehicle; and
a controller that is configured to:
receive fingerprint information from the vehicle through the communication unit,
determine whether the fingerprint recognized by the fingerprint scanner matches the fingerprint information,
based on a determination that the fingerprint matches the fingerprint information, determine a graphic,
provide, through the communication unit to the display, the graphic to be displayed on the display.

2. The mobile terminal of claim 1, wherein the mobile terminal stores data about a plurality of access rights, each of the access rights defining a user's capability to control one or more operations of the vehicle, and
wherein the controller is configured to:
based on a determination that the fingerprint matches the fingerprint information, provide a first access right of the access rights to the vehicle, and
based on a determination that the fingerprint does not match the fingerprint information, provide a second access right of the access rights to the vehicle, wherein the second access right is a lower level access right than the first access right.

3. The mobile terminal of claim 2, wherein the controller is configured to:
in a state in which a current access right is provided to the vehicle, determine whether subsequent user input that is received by the user interface matches the fingerprint information, and
based on a determination that the subsequent user input matches the fingerprint information, update the current access right with the first access right.

4. The mobile terminal of claim 2, wherein each of the access rights defines how many applications, among one or more applications operated by the mobile device, are operable for the vehicle under the access right.

5. The mobile terminal of claim 2, wherein the controller is configured to:
in a state in which the first access right is provided to the vehicle, perform a first operation in response to user input that is received through a vehicle user interface of the vehicle, and
in a state that the second access right is provided to the vehicle, perform a second operation in response to user input that is received through the vehicle user interface, and
wherein the first operation is different from the second operation.

6. The mobile terminal of claim 1, wherein the controller is configured to:
based on a determination that the fingerprint matches the fingerprint information, control the communication unit to provide a first graphic to the display, and
based on a determination that the fingerprint does not match the fingerprint information, control the communication unit to provide a second graphic to the display, and
wherein the second graphic is different from the first graphic.

7. The mobile terminal of claim 6, further comprising:
a memory that is configured to store a plurality of applications including a first group of applications and a second group of applications,
wherein the first graphic includes a first graphical element for an application in the first group of applications, and
wherein the second graphic includes a second graphical element for an application in the second group of applications.

8. The mobile terminal of claim 6, wherein the first graphic includes a first user interface that is configured to:
receive first user input applied to the first user interface, and
in response to the first user input, display a home screen on the display, and
wherein the second graphic does not include a user interface that is configured to display a home screen on the display.

9. The mobile terminal of claim 1, wherein the controller is configured to:
receive first user input through the user interface of the mobile terminal and second user input through a vehicle user interface of the vehicle,
determine (i) whether the second user input is received within a first time period from a moment at which the first user input is received or (ii) whether the first user input is received within the first time period from a moment at which the second user input is received, and
based on (i) a determination that the second user input is received within the first time period from the moment at which the first user input is received or (ii) a determination that the first user input is received within the first time period from the moment at which the second user input is received, provide the graphic to the display through the communication unit, and
wherein the fingerprint information is generated based on the second user input.

10. The mobile terminal of claim 9, wherein the controller is configured to:
based on a determination that the second user input is received within the first time period from the moment at which the first user input is received, control the communication unit to establish a first type of connection between the vehicle and the mobile terminal.

11. The mobile terminal of claim 10, wherein the controller is configured to:
in a state in which the first type of connection is established, receive third user input that is applied to the vehicle user interface through the communication unit, and
based on the third user input, control the display to display a third graphic.

12. The mobile terminal of claim 11, wherein the controller is configured to:
determine whether the vehicle is in a manual driving mode or an autonomous driving mode, and
based on a determination that the vehicle is in the manual driving mode or the autonomous driving mode, determine a graphic to be displayed on the display regardless of user input applied to the vehicle user interface.

13. The mobile terminal of claim 9, wherein the controller is configured to:
determine whether at least one of the first user input or the second user input is received, and
based on a determination that the at least one of the first user input or the second user input is received, control, through the communication unit, the display to display guidance information indicating when the first time period lapses.

14. The mobile terminal of claim 9, wherein the controller is configured to:
based on (i) a determination that the second user input is not received within the first time period from the moment at which the first user input is received or (ii) a determination that the first user input is not received within the first time period from the moment at which the second user input is received, control the display not to display the graphic.

15. The mobile terminal of claim 1, wherein the controller is configured to:
determine whether third user input is received through the user interface, and
control the communication unit to provide, to the vehicle, a message requesting the fingerprint information.

16. A vehicle control device for controlling a vehicle that includes a display and a steering wheel, the vehicle control device comprising:
a vehicle user interface that is configured to receive user input;
to a fingerprint scanner that is coupled to the steering wheel, that is located adjacent to the vehicle user interface, and that is configured to recognize a fingerprint from the user input received through the vehicle user interface;
a communication unit that is configured to communicate with a mobile terminal, the display, and the vehicle user interface; and
a processor that is configured to:
receive fingerprint information from the mobile terminal through the communication unit,
determine whether the fingerprint recognized by the fingerprint scanner matches the fingerprint information,
based on a determination that the fingerprint matches the fingerprint information, determine a graphic,
provide, through the communication unit to the display, the graphic to be displayed on the display.

17. The vehicle control device of claim 16, wherein the vehicle control device stores data about a plurality of access rights, each of the access rights defining a user's capability to control one or more operations of the vehicle, and
wherein the processor is configured to:
based on a determination that the fingerprint matches the fingerprint information, provide a first access right of the access rights to the mobile terminal, and
based on a determination that the fingerprint does not match the fingerprint information, provide a second access right of the access rights to the mobile terminal, wherein the second access right is a lower level access right than the first access right.

18. The vehicle control device of claim 17, wherein each of the access rights defines how many operations, among one or more operations of the vehicle, are operable using the mobile device under the access right.

19. The vehicle control device of claim 17, wherein the processor is configured to:
in a state in which the first access right is provided to the mobile terminal, perform a first operation in response to user input that is received through a user interface of the mobile terminal, and
in a state that the second access right is provided to the mobile terminal, perform a second operation in response to user input that is received through the user interface, and
wherein the first operation is different from the second operation.

20. The vehicle control device of claim 16, wherein the processor is configured to:
based on a determination that the fingerprint matches the fingerprint information, control the communication unit to provide a first graphic to the display, and
based on a determination that the fingerprint does not match the fingerprint information, control the communication unit to provide a second graphic to the display, and
wherein the second graphic is different from the first graphic.
